(19) United States
(12) Patent Application Publication
(10) Pub. No.: US 2016/0334575 A1
(43) Pub. Date: Nov. 17, 2016

(54) System and Method for Photonic Switching

(71) Applicant: Huawei Technologies Co., Ltd., Shenzhen (CN)

(72) Inventors: Alan Frank Graves, Kanata (CA); Dominic John Goodwill, Ottawa (CA); Patrick Dumais, Ottawa (CA)

(21) Appl. No.: 14/710,272

(22) Filed: May 12, 2015

(51) Int. Cl. G02B 6/126

(52) U.S. Cl. CPC G02B 6/126; G02B 2006/12145

(57) ABSTRACT

A method for photonic device includes an optical macromodule substrate including optical interconnects and a first photonic integrated circuit (PIC) including a first photonic switch, where the first PIC is mechanically coupled to the optical macromodule substrate and optically coupled to the optical interconnect. The photonic device also includes a PIC controller electrically coupled to the first PIC.

### TECHNICAL FIELD

The present invention relates to a system and method for photonics, and, in particular, to a system and method for photonic switching.

### BACKGROUND

Data centers route massive quantities of data. Currently, data centers may have a throughput of 5-10 terabytes per second, which is expected to increase in the future. Data centers contain huge numbers of racks of servers, racks of storage devices, and other racks often with top-of-rack (TOR) switches, all of which are interconnected via massive centralized packet switching resources. In data centers, electrical packet switches are used to route all data packets, irrespective of packet properties, in these data centers. However, electrical packet switches have limited speeds and throughput capacities, which may utilize complex multi-layer core networks of such switches to implement large data centers. However, large photonic switches may provide a throughput capacity to produce a single layer data center core. Hence photonic switching may be desirable for packet switching in data centers.

### SUMMARY

An embodiment photonic device includes an optical macromodule substrate including optical interconnects and a first photonic integrated circuit (PIC) including a first photonic switch, where the first PIC is mechanically coupled to the optical macromodule substrate and optically coupled to the optical interconnect. The photonic device also includes a PIC controller electrically coupled to the first PIC.

An embodiment photonic switch includes an input stage including a first optical including a first photonic integrated circuit (PIC) switch and a second optical macromodule including a second PIC switch. The photonic switch also includes a center stage including a third optical macromodule including a third PIC switch, where the third optical macromodule is optically coupled to the first optical macromodule and the second optical macromodule and a fourth optical macromodule including a fourth PIC switch, where the fourth optical macromodule is optically coupled to the first optical macromodule and the second optical macromodule. Additionally, the photonic switch includes an output stage including a fifth optical macromodule including a fifth PIC switch, where the fifth optical macromodule is optically coupled to the third optical macromodule and the fourth optical macromodule and a sixth optical macromodule including a sixth PIC switch, where the sixth optical macromodule is optically coupled to the third optical macromodule and the fourth optical macromodule.

An embodiment method includes receiving an input optical stream and producing a first split optical stream having a first polarization and a second split optical stream having the first polarization from the input optical stream by a polarization splitter/rotator. The method also includes switching the first split optical stream to produce a first switched optical stream by a first optical switch and amplifying the first switched optical stream to produce a first amplified optical stream by a first amplifier. Additionally, the method includes switching the second optical stream to produce a second switched optical stream by a second optical switch and amplifying the second switched optical stream to produce a second amplified optical stream by a second amplifier. Also, the method includes combining the first amplified optical stream and the second amplified optical stream to produce a polarization agnostic optical stream by a polarization rotator/combiner.

The foregoing has outlined rather broadly the features of an embodiment of the present invention in order that the detailed description of the invention that follows may be better understood. Additional features and advantages of embodiments of the invention will be described hereinafter, which form the subject of the claims of the invention. It should be appreciated by those skilled in the art that the conception and specific embodiments disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawing, in which:

FIG. 1 illustrates an embodiment Clos switch;

FIG. 2 illustrates an embodiment photonic switching structure;

FIG. 3 illustrates an embodiment optical macromodule;

FIG. 4 illustrates an embodiment photonic switching module;

FIG. 5 illustrates an embodiment PIC controller;

FIG. 6 illustrates another embodiment optical macromodule;

FIG. 7 illustrates an embodiment electronics control module;

FIG. 8 illustrates another embodiment photonic switching module;

FIG. 9 illustrates another embodiment electronic control module;

FIGS. 10A-B illustrate an additional embodiment optical macromodule;

FIGS. 11A-D illustrate single polarization systems;

FIG. 12 illustrates a single polarization system;

FIG. 13 illustrates an embodiment polarization agnostic application of polarization dependent elements;

FIG. 14 illustrates an embodiment polarization splitter/rotator;

FIGS. 15A-C illustrates an embodiment optical macromodule structure;

FIG. 16 illustrates an embodiment photonic switching matrix array;

FIG. 17 illustrates an embodiment optical waveguide crossing;

FIG. 18 illustrates an embodiment array of optical amplifiers;

FIG. 19 illustrates an embodiment mirror optical coupler;

FIG. 20 illustrates an embodiment optical grating coupler;

FIG. 21 illustrates an embodiment optical beam expander;

FIG. 22 illustrates an embodiment optical power splitter;

FIG. 23 illustrates another embodiment optical macromodule;

FIGS. 24A-C illustrate an embodiment photonic switch;

FIG. 25 illustrates an embodiment input stage module;

FIG. 26 illustrates an embodiment center stage module;

FIG. 27 illustrates an embodiment output stage module;

FIGS. 28A-C illustrates another embodiment photonic switch;

FIG. 29 illustrates another embodiment input stage module;

FIG. 30 illustrates another embodiment center stage module;

FIG. 31 illustrates another embodiment output stage module;

FIGS. 32A-C illustrates an additional embodiment photonic switch;

FIG. 33 illustrates an additional embodiment input stage module;

FIG. 34 illustrates an additional embodiment center stage module;

FIG. 35 illustrates an additional embodiment output stage module; and

FIG. 36 illustrates a flowchart of an embodiment method of photonic switching.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION OF ILLUSTRATIVE EMBODIMENTS

It should be understood at the outset that although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

An embodiment photonic switching module has precision lithographically defined optical interconnect to form a skew-controlled optical switch with multiple photonic integrated circuits (PICs) per switching module referred to as a macromodule or an optical macromodule. Skew is a timing offset between two signals that originally were aligned to a common timing reference, the offset resulting from the signals having propagated along different physical paths with different physical delays. Optical macromodules may be polarization agnostic or polarization specific, depending on the functionality incorporated into them and the polarization-agnostic or polarization-specific nature of that functionality. An embodiment has a high per-module switching capacity with multiple switching PIC matrices in an array on the optical macromodule. These arrays of PIC switches are placed on a larger area, lower lithographic density, interconnect optical macromodule substrate with control circuits directly mounted on the PICs. Hybridized arrays of semiconductor optical amplifiers (SOAs) on the substrate, with SOA controllers associated with the SOAs, are used to compensate for optical loss, for example in the PICs and optical macromodule components. Pairs of sets of single polarization PICs and SOAs are placed between an input array of polarization splitters/rotators and an output array of polarization rotators/combiners for a polarization-agnostic photonic switching module.

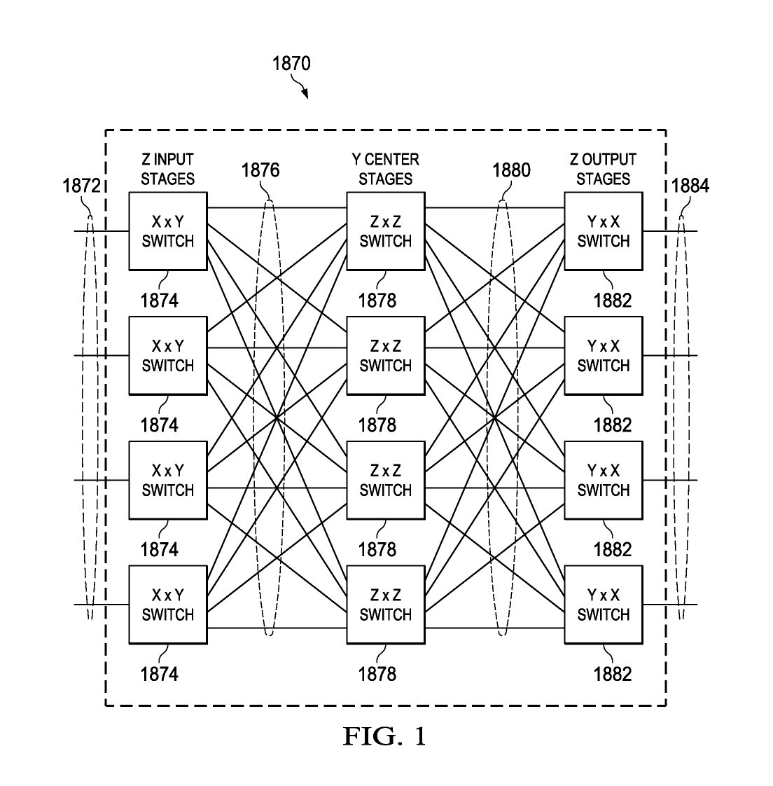

A photonic switch may be composed of switching stage modules in parallel and/or in series, for example in a Clos switch. FIG. 1 illustrates Clos switch 1870 with input signals 1872, which are fed to input stage fabrics 1874, X by Y switches. A junctoring pattern of connections 1876 provides equal connectivity between each input stage fabric 1874 and each center stage fabric 1878, which are Z by Z switches. X, Y, and Z are positive integers. Also, a junctoring pattern of connections 1880 provides equal connectivity between each center stage fabric 1879 and each output stage fabric 1882, which are Y by X switches, to connect every fabric in each stage equally to every fabric in the adjacent stage of the switch. A dilating Clos switch whereby Y>X has good blocking characteristics, and a dilating Clos switch fabric whereby Y>˜2X is a non-blocking fabric. Output stage fabrics 1882 produce outputs 1884 from input signals 1872 which have traversed the three stages. Four input stage fabrics 1874, center stage fabrics 1878, and output stage fabrics 1882 are pictured, but more stages (e.g. 5-stage Clos) or fabrics per stage may be used. In an example of a 3 stage Clos, there are the same number (Z) of input stage fabrics 1874 and output stage fabrics 1882, with a different number (Y) of center stage fabrics 1878, where Y is equal to Z times the number of input stage outputs per stage module divided by the number of center stage inputs per stage module. As an example, a switch of 1024 input ports, built from 32×64 input stages, 32×32 center stages and 64×32 output stages has 32 input stage modules, 64 center stage modules, and 32 output stage modules. The effective input and output port count of Clos switch 1870 is equal to the number of input stage fabrics (Z) multiplied by X, for the input port count, by the number of output stage fabrics (Z) multiplied by X for the output port count. In an example, Y is equal to 2X−1, and Clos switch 1870 is at the non-blocking threshold. In another example, X is equal to Y, and Clos switch 1870 is conditionally non-blocking. In this example, existing circuits may be rearranged to clear some new paths. A non-blocking switch is a switch that connects N inputs to N outputs in any combination, irrespective of the traffic configuration on other inputs or outputs. A similar structure can be created with five stages for larger fabrics, with two input stages in series and two output stages in series. Clos switches use an odd number of stages with multiple modules in parallel in stage. The interconnect between the stages is orthogonal, in that each module of a given stage is connected to each module of an adjacent stage. With 1:2 dilation, there is a maximum port count for a threes stage Clos switch of ½ *N² for an N×N square switching module. This may limit the capacity of the overall switch.

Thus, it is desirable to combine PICs to create larger switch modules from which to fabricate the switch to increase the overall port count. Combining PICs may facilitate an increased number of ports in a photonic switching structure. An embodiment photonic switch includes an optical macromodule, which has a large area substrate with lithographically-defined optical interconnect which includes monolithic photonic structures, such as interconnection waveguides, polarization splitters and combiners. There is a coarser geometry for the structures on the optical macromodule than for the PICs. For example, the optical macromodules may contain silicon dioxide waveguides having a waveguide width of 5 microns, and the PICs may include silicon waveguides having a waveguide width of 0.5 microns. The optical macromodule substrate may be manufactured using a low resolution photolithographic process such as contact lithography to facilitate a large maximum substrate area, for example an area 20 cm by 20 cm. The PIC may be manufactured using a high resolution photolithographic process, such as stepper lithography, which has a relatively small area, for example an area 2 cm by 2 cm, which is much smaller than the area of the optical macromodule. Thus, multiple PICs can be combined in one optical macromodule.

A small array of PICs on an optical macromodule may be used for a large port count switch module, which may be used as part of a larger switch fabric. Both PICs and array structures may be square with the same number of inputs and outputs, or rectangular with different numbers of inputs and outputs. For example, a 2×2 array of N×2N switch PICs may yield a dilating switch stage of 2N×4N, and a 2×4 array of N×N switch PICs may also yield a dilating switch stage of 2N×4N.

Additionally, using a matrix of PICs on an optical macromodule, the input and output signals may be achieved using integrated power splitters and combiners in the optical macromodule substrate. Power splitters and combiners may be used to direct optical signals to multiple switching modules or PICs. The optical macromodule may also include semiconductor optical amplifiers (SOA) to amplify the optical signals and compensate for optical losses.

The incoming optical signal with an arbitrary polarization has a sum of two orthogonal polarizations. However, it is problematic to make a PIC that acts identically on both polarizations. Thus, the PICs may contain single-polarization switches and the PICs may be arranged as pairs of PICs, each handling one of the two orthogonal polarizations in a polarization diversity scheme. The light in each polarization encounters a different physical path, which may create skew between the light of the two polarizations. This skew may produce a large degradation in the optical signal quality. Thus, the pair of PICs may be arranged on a lithographically defined optical macromodule, which includes polarization splitter and polarization combiner components implemented monolithically with precision lithography on the optical macromodule substrate. The waveguides on the optical macromodule substrate may also control path lengths to minimize the skew between the light of the two polarizations. At bit rates of around 100 Gb/s, transmitted as 4×25 Gb/s signals, the symbol period is around 40 ps. The signal may tolerate a skew between the two polarizations of around 10% to 30% of the symbol period, which is around 4 ps to 12 ps. In glass, this corresponds to a distance of about 0.8 mm to 2.4 mm path length difference between the polarization diverse paths.

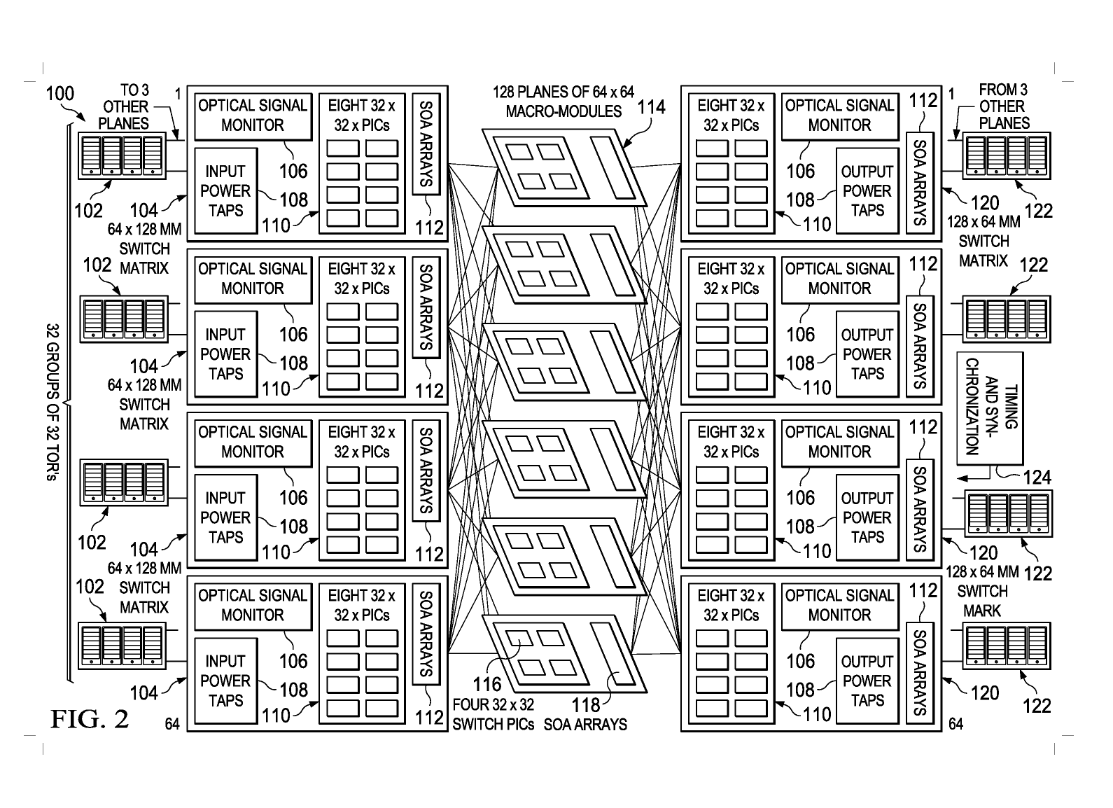

FIG. 2 illustrates a 4096×4096 port photonic switching structure 100 which uses a Clos switching structure with optical macromodules. Input photonic signals come from top of rack switches (TORs) 102. There are 64 groups of 64 TORs. The TORs aggregate the traffic to and from their subtending equipment, for example large arrays of servers per TOR. The input photonic signals are switched by input stage switching optical macromodules 104 having 64 inputs and 128 outputs, which yields a 1:2 dilation. There are 128 input stage switching optical macromodules. The input stage switching optical macromodule contain optical signal monitors 106, optical power taps 108, eight 32×32 photonic switch PICs 110 arranged as a 2×4 matrices, and SOAs 112. Each input stage switching matrix is coupled to each of center stage switching macromodules 114, which contain 64 inputs and 64 outputs. There are 128 center stage switching macromodules. The center stage switching macromodules 114 contain SOAs 118 and four 32×32 photonic switch PICs 116. Each center stage switching macromodule is coupled to each of output stage switching macromodule 120, which have 128 inputs and 64 outputs, which removes the 1:2 dilation. There are 128 output stage switching macromodules. The output stage switching macromodules contain eight 32×32 photonic switch PICs 110 arranged as a 2×4 matrix, SOAs 112, optical signal monitors 106, and optical power taps 108. The output switching stages are coupled to TOR switches 122. Timing is coordinated by timing and synchronization block 124. FIG. 2 shows a single polarization switching solution, but by doubling the number of switch PICs per macromodule and incorporating the polarization splitting and combining components, a polarization-agnostic switch may be created. Switches of lower port count may be created by using fewer PICs per macromodule, smaller PICs, or both.

An embodiment macromodule based three stage Clos switch is illustrated by photonic switching structure 100 in FIG. 2. The dilation is 1:2, for a fully non-blocking switch which is not directly addressable from the interactions between connection paths in a Clos switch. A lower dilation switch may be used, which is not fully non-blocking. In a directly addressable switch, the input-output port addresses are used directly to set up the switch paths with no further address processing or path search for any set of input-output connections. Photonic switching structure 100 provides a 4096×4096 non-blocking switch based on a photonic space switch organized as a three-stage 1:2 dilated Clos switch, with eight PIC switches with sizes of 32×32 in each of the input stages and output stages, creating 64×128 input and output stage modules. Four 32×32 PICs are used in each of the center stages, for 64×64 center stage modules. Photonic switching structure 100 is a single polarization switch with strict polarization control and polarization maintaining interconnect for internal inter-stage connections and input connections. Thus, FIG. 2 shows a single polarization implementation. A polarization-agnostic version would have twice the number of PICs, SOAs, etc., per macromodule plus the additional polarization splitting, rotating, and combining components. The polarization paths are recombined at the outputs of the optical macromodules to avoid doubling the inter-macromodule connectivity and to prevent the inter-macromodule interconnect, which is potentially a source of a high level of skew, from contributing that skew into the polarization diversity skew budget. However, the inter-macromodule interconnect skew will contribute to of inter-container skew, where the gap between switched containers is modulated by the skew across the entire switch.

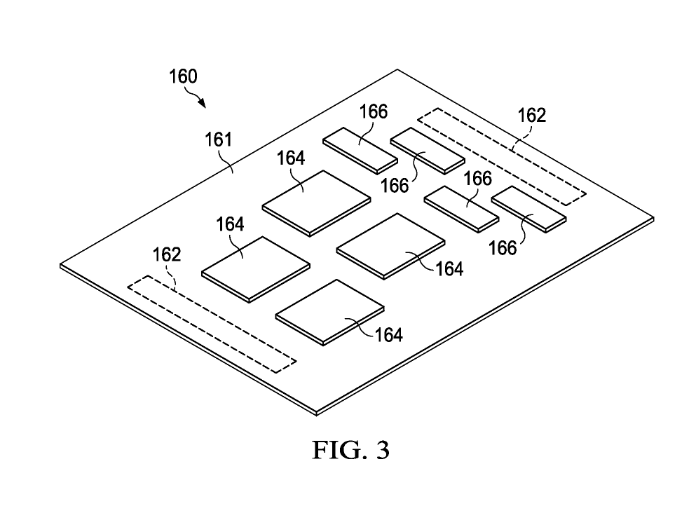

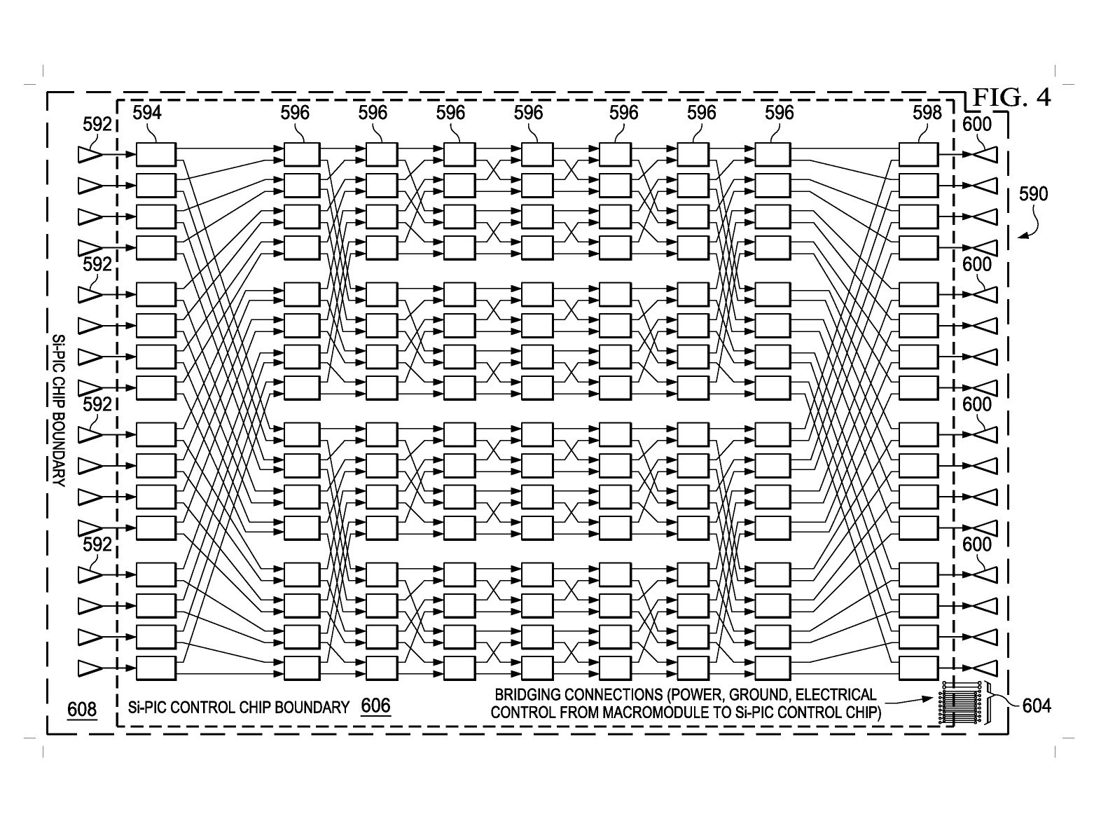

FIG. 3 illustrates optical macromodule 160, an embodiment macromodule with a large area lithographically defined optical integrated substrate 161 having monolithically integrated components, such as power splitters, power combiners, polarization splitters, polarization rotators, and polarization combiners, which are integrated on the macromodule optical substrate. The macromodule substrate contains optical interconnect, including optical path crossovers, which may be at right angles in the same optical plane, or may be bridges in a second optical plane. Areas 162 may contain monolithic integrated power splitters, polarization splitters, and combiners. PICs 164 contain Nᵢ×Nₒ photonic switching modules where Nᵢ and Nₒ represent, respectively, the number of input ports and the number of output ports, and may be equal or different values. Hybridized components 166 include controller chips and SOA arrays. The optical interconnect includes coupling into and out of the substrate, for example edge coupling to fibers or expanded beam connectors, surface gratings coupled to attached fibers, or grating termination hybridized devices or fibers, or micro-mirrors use to couple light between the substrate and the hybridized device. The PICs may have control application specific integrated circuit (ASICs) bonded to their optically active surface. The use of an array of macromodules, each with an array of PICs per macromodule, facilitates the building up of a large three stage photonic switches, as shown in FIG. 2. For use in a data center, this switch may be controlled very rapidly. A control structure calculates the center stage connections using the outputs of the input stage map and the inputs of the output stage maps derived from an interaction between the input stage-associated controllers and output-stage associated controllers which cooperate to form a distributed series/parallel pipelined control system. Additional details on these input stage controllers and output stage controllers, their interactions and the resultant control of the photonic structure are further discussed in U.S. patent application Ser. No. 14/455,034 filed on Aug. 8, 2014, and entitled “System and Method for Photonic Networks,” which this application incorporates hereby by reference.

FIG. 4 illustrates photonic switching module 590, a 16×16 hybrid dilated Benes (HDBE) switch fabricated by an interconnected array of 2×2 and 1×2 switch elements on a PIC chip, for example on a PIC. The switch elements are 1×2 or 2×2 switches formed by a Mach-Zehnder interferometer based electro-optic switching cell, where a control signal causes an effective change in the refractive index on one arm of the Mach-Zehnder interferometer, changing the optical phase leading to complete destructive interference or complete constructive interference. PIC chip 608 contains optical inputs 592, optical outputs 600, and electrical connections 604, which includes power, ground, and electrical control from the macromodule to the PIC chip. It also includes PIC control chip boundary 606, where the control chip is mounted over the PIC. Also, the PIC contains optical inputs 592, optical switches 596, and optical outputs 587.

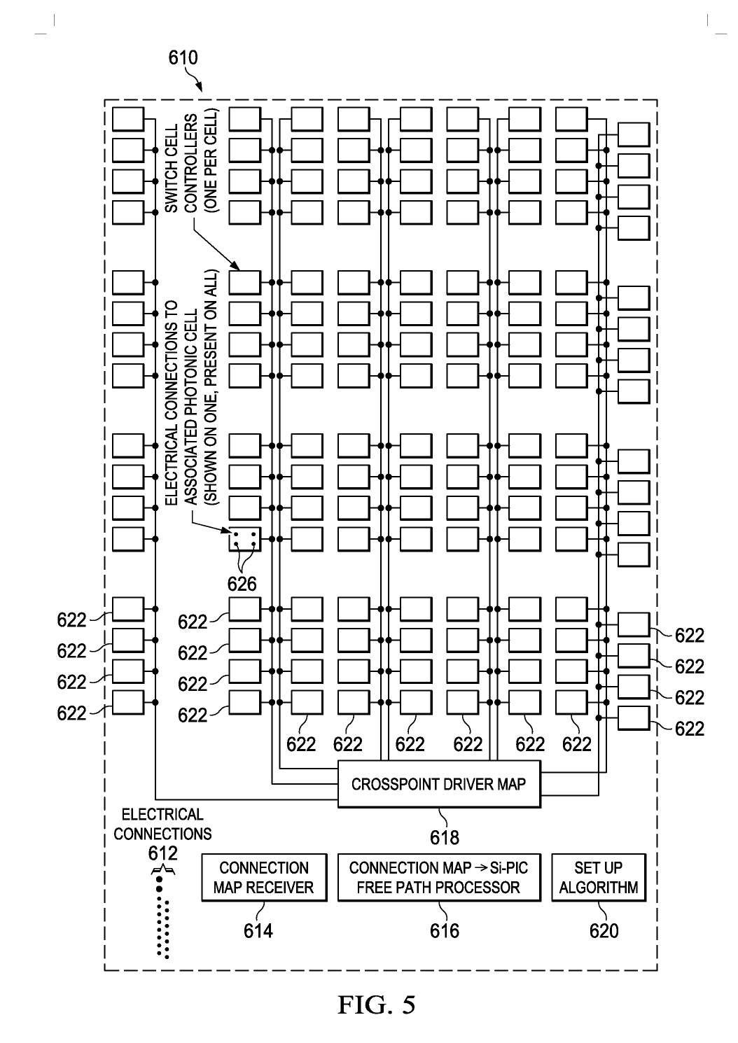

FIG. 5 illustrates a PIC control chip 610, which may by mounted on a PIC, for example on photonic switching module 590. PIC control chip 610 contains connection map receiver 614, connection map to free path processor 616, set-up algorithm 620, and crosspoint driver map 618. Crosspoint driver map 618 drives the crosspoint switches using switch cell controllers 622, which have electrical connections 626. One switch cell controller controls one cell, with a direct electrical connection between the cell controller and the cell which drives an electrical control signal into the electro-optic Mach Zehnder of that cell. The cell controllers may be mounted directly above the cell they control by direct face-to-face chip bonding between the PIC and the electrical control ASIC, for example using micro-solder bumps, providing for direct electrical connections. Because the PIC will subsequently be mounted face-down on the macromodule substrate to optically couple the PIC to the macromodule, the control chip may be accommodated in a well, aperture, or hole in the macromodule, and may receive its electrical power and system connections via a bridge to the macromodule substrate formed through the larger area PIC as is shown in FIGS. 4 and 5.

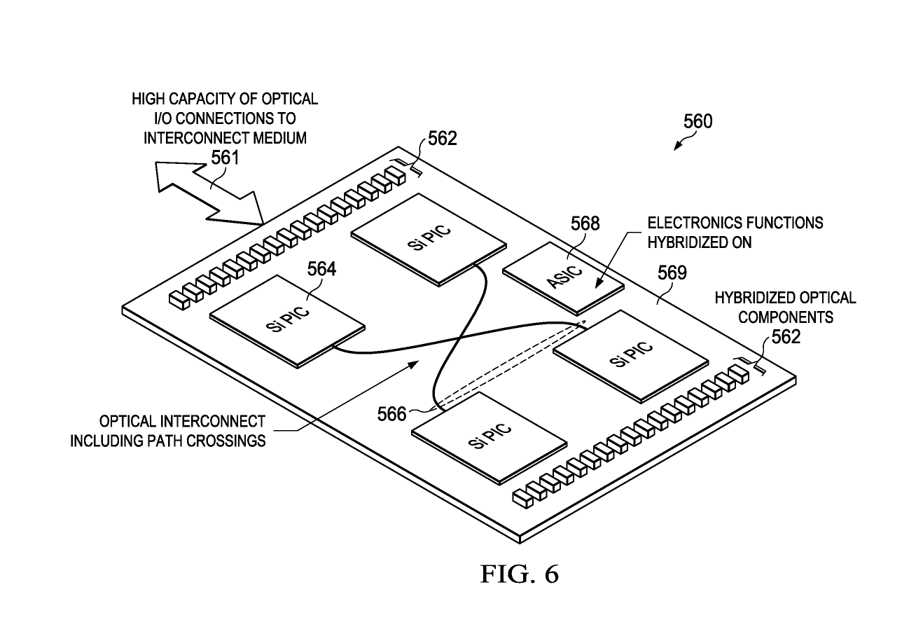

An optical macromodule is a limited area, highly dense, and accurately dimensioned optical substrate which provides both high density interconnectivity and high density optical coupling and interconnect. The substrate may be silicon, silicon on insulator, silica on silicon, or another substrate, or another optically active layer, which may be a silicon based substrate, with silicon nitride, or a non-silicon based substrate, for example with polymer-based active layers. When optical macromodules are used, active optical functions, such as arrays of switch matrix PICs are hybridized on the macromodule surface, along with other electronic, photonic, and/or electro-photonic functions leading to a complete component switching fabric. FIG. 6 illustrates optical macromodule 560, a large area precision substrate with optically dense interconnect 566. The optical macromodule optically, electrically, physically, and mechanically interfaces with optical components, such as an array of PICs and/or other components, such as SOAs, to create complex photonic functions. The optical interconnect includes optical path crossings, which facilitate two optical tracks crossing each other in the same plane at right angles with low interference and low optical loss. PICs 564 are mounted on and aligned to optical macromodule substrate 569 to have a low optical loss across the PIC-macromodule interface, along with ASIC 568, which is also mounted on the optical macromodule. The ASICs may be mounted over the PICs. The scale of the optical macromodule may be about several inches, for example 1.5-5 inches (37-125 mm) on a side, with a precision of a few microns in the substrate, while the PICs may be about 25×32 mm with a precision of about 0.2 μm or less. The PICs may be, for example, about 10-25 mm per side. The monolithic electronic ASIC may be hybridized on to the substrate. An ASIC which controls the PIC may be mounted directly on the controlled PIC. Additional photonic components 562, such as SOA arrays, are hybridized on the optical macromodule with the optical and electrical connections to the optical macromodule. Accurate placement of the components on the optical macromodule facilitates low optical losses. Optical interconnect 561 contains high capacity optical input/output (I/O) connections which optically couple to/from the optical macromodule, for example to optical fibers or optical connectors.

Table 1 illustrates some characteristics of optical waveguides fabricated from silicon, silicon nitride, and silicon dioxide. The three optically active material layers have different properties. In addition, various structures may transition between layers or materials systems for mixing of these materials. Silicon or silicon nitride waveguides may use amplification, which may be hybridized SOAs, while silicon dioxide waveguides may use hybridized SOAs or erbium doped waveguide amplifiers (EDWAs), which are optically powered by pumping the amplifier, implemented by doping the silicon dioxide waveguide with erbium ions, pumped with 980 nm or 1480 nm light. EDWAs are polarization-insensitive, and may be used outside polarization-split paths, halving the number of amplifiers. Also, high electrical power burn, and consequent heat production is at the remotely located pump laser rather than on the optical macromodule at the amplifier sites.

TABLE 1

| Material | Silicon | | Silicon Nitride | Silicon Dioxide |
|---|---|---|---|---|
| Waveguide width | 500 | nm | 800 nm | 3 μm-10 μm |
| Waveguide height | 220 | nm | 400 nm | 3 μm-10 μm |
| Waveguide pitch | 3 μm-5 μm | | 5 μm-10 μm | 10 μm-60 μm |
| Minimum waveguide | 5 | μm | 40 μm-50 μm | 100 μm-250 μm |
| bend radius | | | | |

| | | | |
|---|---|---|---|
| Substrate Size | Small | Large | Very large |
| Amplification | SOA | SOA | EDWA or SOA |

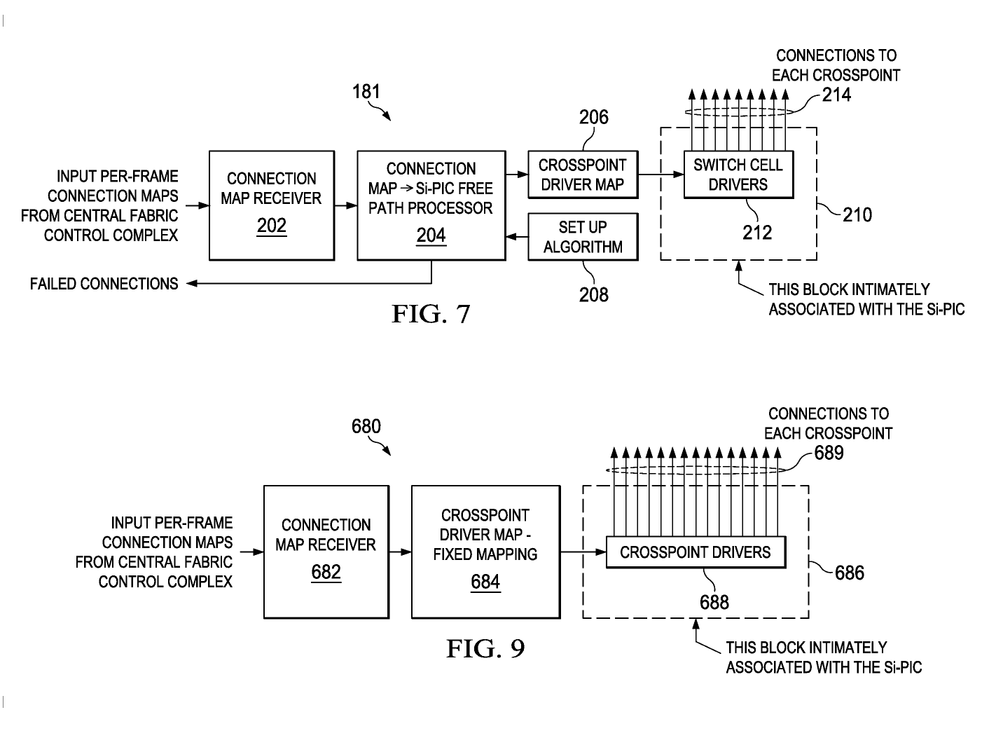

An optical macromodule combines arrays of PICs, ASICs, and other functions, both monolithically integrated into an optical connection matrix of an optical macromodule substrate and hybridized on its surface. FIG. 7 illustrates control module 181, a control module which may be used, for example, to control photonic switching module 590. Control module 181 includes connection map receiver 202, which receives an input per-frame connection map from a central control complex such as that detailed in Ser. No. 14/455,034. Connection block 204 converts the received connection map to a set of cell drive instructions for the connections so those connections use separate cell paths across the switch, using a set up algorithm provided by algorithm 208. Various forms of algorithm 208 may be used, where switch fabric 590 is a conditionally non-blocking matrix. Hence, in some situations, not all requested connections within the matrix are set up in time for a given frames connection map. In this case, a connection fail line from block 204 notifies the central control complex of connections which will not be completed, and that complex requests a retransmission of the affected data from the source TOR photonic peripheral, which has held a copy of the data in a store. The successful connections are output to crosspoint drive map 206, which populates the crosspoint driver map. Switch cell drivers 212, in block 210, may be intimately associated with the PIC due to the high number of connections to connect to every cell of the PIC. For example, the switch cell driver function may be mounted directly over the PIC it controls. The switch cell drivers drive the crosspoints using connections 214.

FIG. 8 illustrates photonic switch 660, an expand and select (EAS) PIC topology which uses a larger amount of silicon and a higher crosspoint cell count, but which is strictly non-blocking, has good crosstalk properties, and is directly addressable without a free path search. There are multiple layers of 1×2 switches, switches 662 coupled to switches 664, which are coupled to switches 666. Then, switches 666 are coupled to switches 668 and switches 670 to form a binary controlled expansion tree. Switches 668 and 670 are coupled to each of switches 672 and 674 by an intermediate 256×256 orthogonal connection field. Switches 672 and 674 are coupled to switches 676, which are also coupled to switches 678. Also, switches 678 are coupled to switches 679, creating a select tree with one branch of each select being connected to one branch of each expansion tree. Because each switch cell in the EAS PIC is a binary 1×2 or 2×1 switch, it may be driven by a single bit of the address, and the expansion tree may be driven by the output address and the select tree by the input or source address.

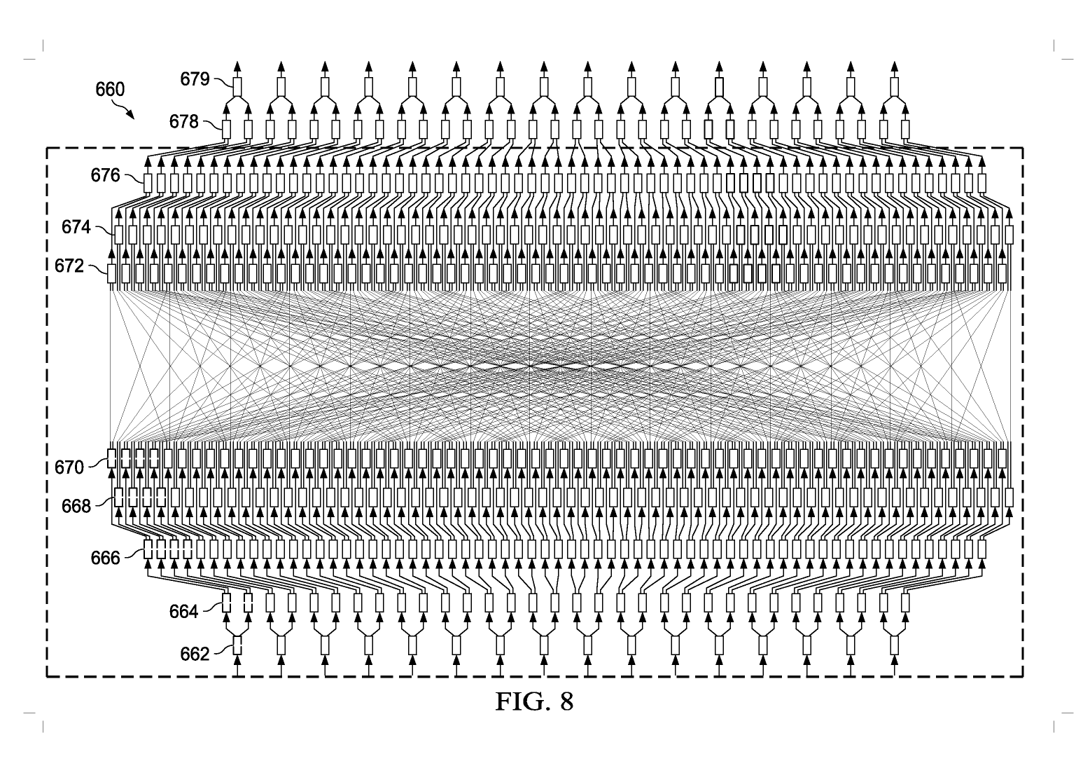

FIG. 9 illustrates control system 680, which may be used, for example, to control photonic switch 660. The connection request maps are received from a central control complex by connection map receiver 682. The connections are mapped by crosspoint driver map 684, a fixed mapping. Crosspoint drivers 688 control the connections to the crosspoints with connections 689. Also, crosspoint drivers 688 are in block 686, which is intimately associated with the PIC, for example mounted over the PIC.

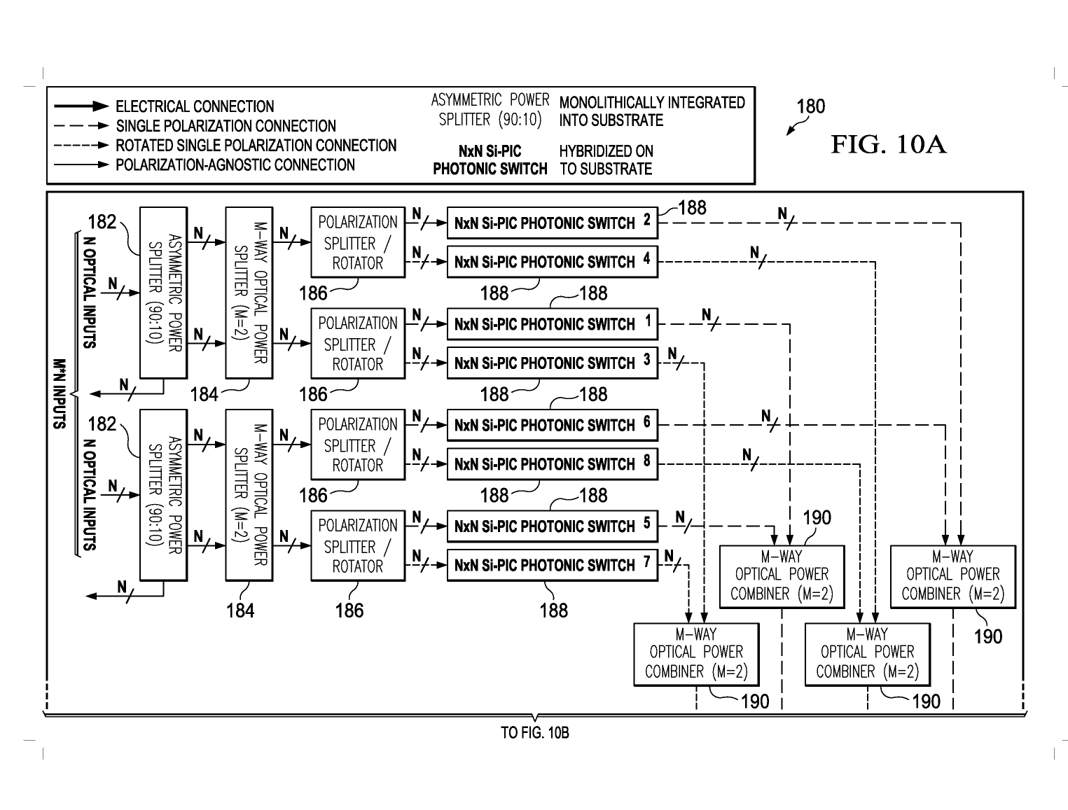

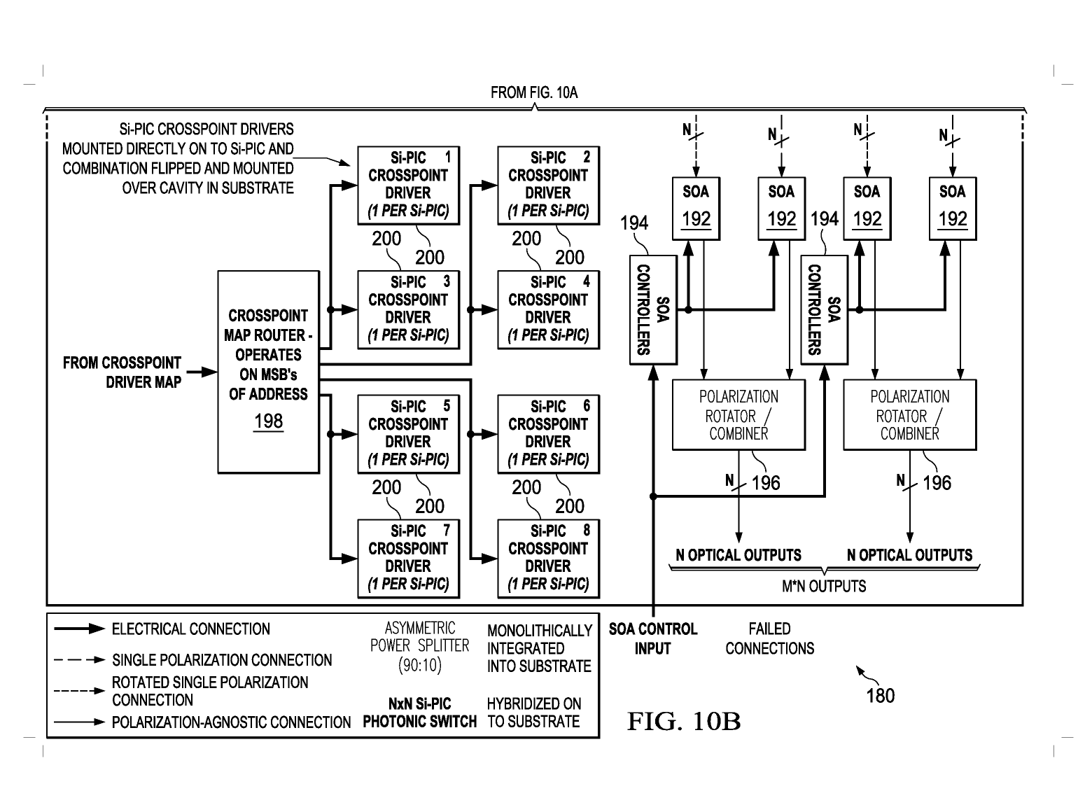

A switch, such as photonic switch 660 or photonic switch 590 implemented in the form of a single PIC, may be used in an optical macromodule switching structure. FIGS. 10A-B show optical macromodule 180. Photonic switching module 180 uses eight hybridized single polarization PICs, PIC photonic switches 188, which are N×N switches. Photonic switching module 180 is a low loss, low skew, polarization agnostic switch with twice the throughput of a single polarization PIC and four times the throughput of an equivalent complexity polarization agnostic PIC. Also, optical macromodule 180 has a port count of Mᵢ*Nᵢ×Mₒ*Nₒ, where M is the array size and N is the port count for each PIC, and suffixes ᵢ and ₒ indicate input and output, respectively. In square switches and square macromodule arrays Nᵢ=Nₒ and Mᵢ=Mₒ. Dilation may be introduced at a 1:2 level by making Nₒ twice Nᵢ (as rectangular switch PIC) or making Mₒ twice Mᵢ (a rectangular array). The macromodule optical path includes hybridized and monolithic devices.

Mᵢ*Nᵢ inputs enter the optical macromodule and are received by power splitters 182, two 90:10 power splitters monolithically integrated on the substrate. 10% of the input optical power is tapped off and fed to a phase comparator, which compares the incoming signal phase with the local switch feeding frame, and clocks the incoming phase, which are fed back to correct the source timing. The remaining optical power is fed to power splitters 184. Power splitters 184 are Mᵢ-way optical power splitters, for example two way monolithic splitters, which produce two nominally identical optical outputs, so that the same optical signal is driven into two paths. The split light is fed to polarization splitters/rotators 186, four polarization rotators and splitters which produce two optical outputs both with polarization in the plane that the PICs are optimized for.

The outputs are fed to photonic switches 188, eight Nᵢ×Nₒ hybridized PIC photonic switches. The crosspoint driver map is fed to crosspoint map router 198, which operates on the most significant bits of the addresses. The map is routed to PIC crosspoint drivers 200, which drive the PICs. There is one PIC crosspoint driver per PIC. The PIC crosspoint drives are directly mounted on the PIC to facilitate electrical connections between the PIC and PIC controller.

The switched outputs are then combined by power combiners 190, four Mₒ-way optical power combiners, where Mₒ=2, and fed into SOAs 192 for amplification to compensate for losses, for example in the power splitter, polarization splitter, PIC, power combiner, and not yet reached polarization combiner, as well as other losses, for example from macromodule optical tracks. The SOAs are controlled by SOA controller block 194. The amplified signals are then combined with signals from the matching polarization by polarization rotators/combiners 196. Finally, Mₒ*Nₒ optical outputs are output. The polarization diverse paths extend from the input to the polarization rotator/splitter to the output of the polarization rotator/combiner, which is matched for each path pair. The optical macromodules may be combined in various switch topologies, including matrixed switches which use a large number of optical macromodules, but are directly addressed, and three stage Clos switches.

Silicon or silica on silicon may be used for the macromodule substrate. Silicon is conducive to integration of electronic functions, while silica is conducive to the integration of optical amplifiers, such as EDWA arrays. Both materials systems, as well as silicon nitride, support integrated passive components such as power splitters and combiners, polarization splitters and combiners, and mode expanders and compressors. Also, silica interfaces well to conventional fibers, because its waveguide propagation mode size is relatively well matched to that of fiber. With silicon waveguides, a mode expander may be used between the waveguide and the fiber. An optical path may go through both silica and silicon on the same substrate.

Large photonic switches may be fabricated from series and/or parallel arrays of switching crosspoint modules. Additional functionality, such as polarization splitting, polarization rotation, and polarization combining are used for pairs of single polarization switches. Also, amplification may be used to compensate for losses.

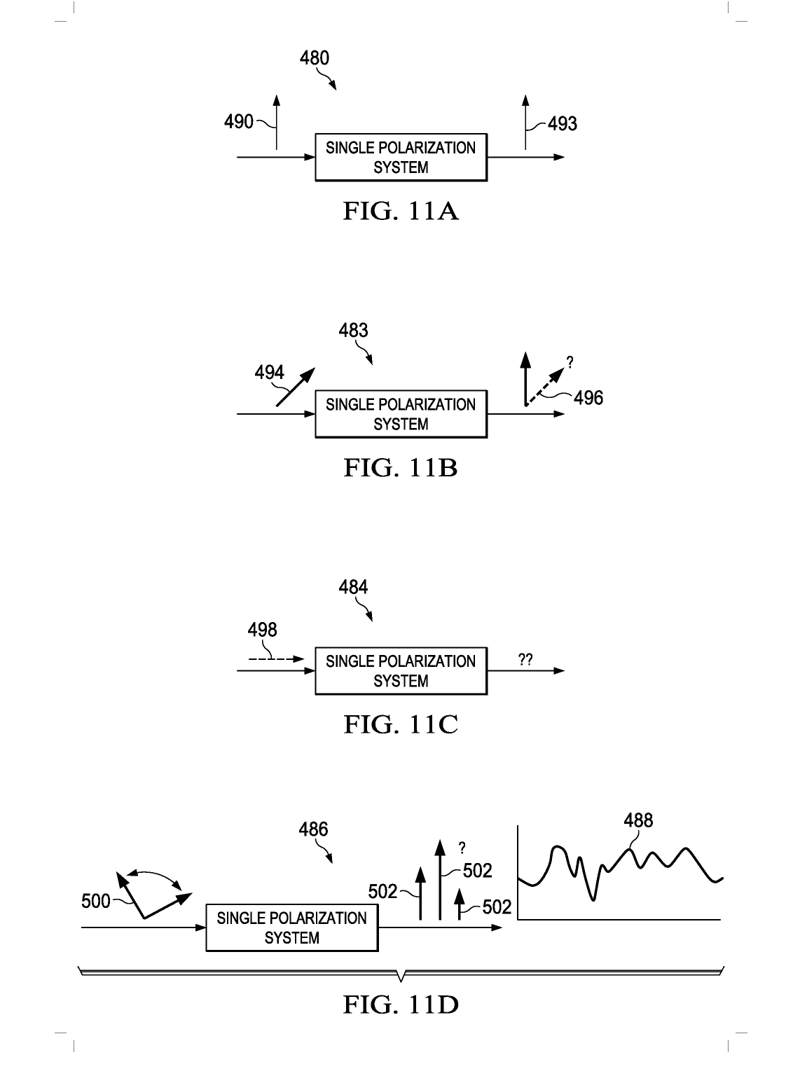

FIGS. 11A-D illustrate examples of the behavior of single polarization systems as the polarization is changed. In a single polarization system, the response depends on the input polarization. The response may be known when the input is at a desired polarization, and may be unknown or a known but unwanted response for other polarizations. In FIG. 11A, single polarization light 490 propagates through single polarization system 480 to produce output polarization 492, the input light is polarized at the polarization for the single polarization system, the vertical arrow representing the polarization plane of the incoming signal and the polarization plane for correct performance of the single polarization device. In FIG. 11B, input light 493 at a different polarization is acted on by single polarization system 483. Output 496 shows the portion of the input light at the desired polarization is acted upon appropriately, but the portion of light at different polarizations has unknown behavior. In FIG. 11C, input light 482 is input to single polarization system 484 in an orthogonal polarization (indicated by the rotated arrow from vertical to horizontal) to the desired polarization for proper device operation, and the behavior of the device is unknown. Also, FIG. 11D shows the impact of changes in the polarization of light, as input light 500 is input to single polarization system 486. A variety of unknown outputs 502 is produced. The polarization changes may occur from changes to optical fibers which are disturbed, or are subject to even mild vibration or small thermal changes. This leads to optical signal variation or modulation. Curve 488 shows example noise from changing optical polarizations.

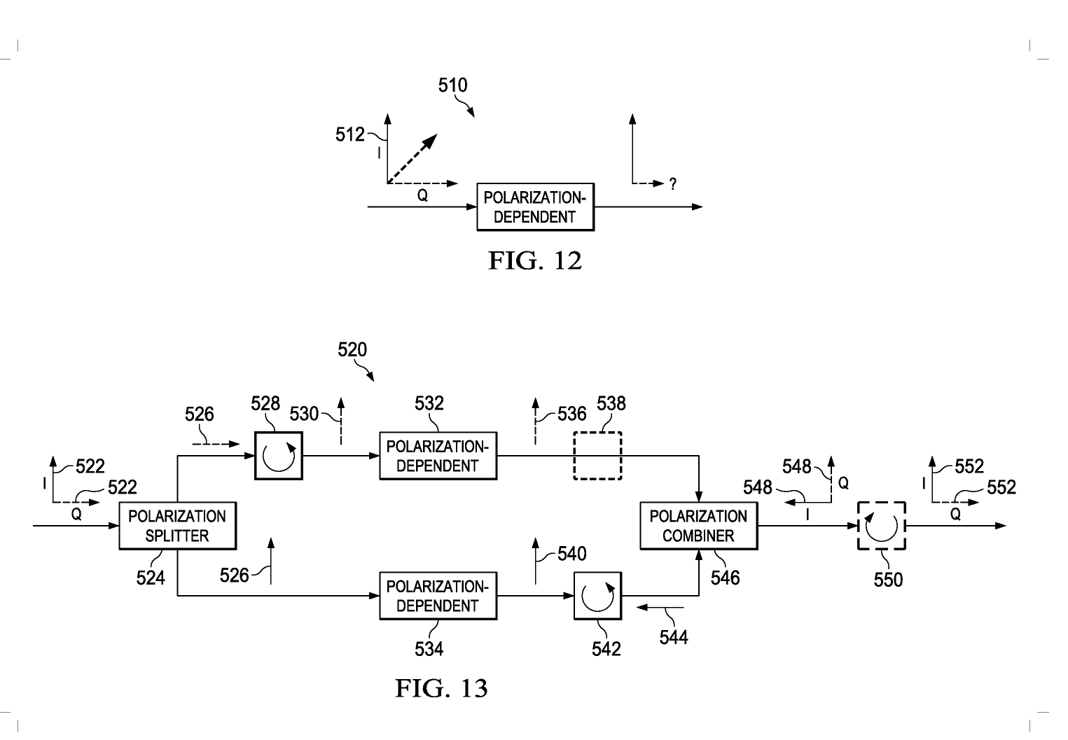

FIG. 12 shows input light 512 at a fixed but non-aligned polarization acted on by polarization dependent optical device 510, which may be a crosspoint switch, SOA, or other single polarization optical function, such as another PIC function. The output performance is unknown.

Polarization diversity may be used to combine two single polarization functions to produce a function in a polarization agnostic manner. FIG. 13 illustrates polarization diversity system 520. Input optical stream 522 is split by polarization splitter 524, which splits the light into two separate streams with orthogonal polarizations. One of the streams is rotated ninety degrees by polarization rotator 528 to form two optical streams 530 and 526 with the same polarization. This may be designed to be the desired polarization for the polarization dependent devices. These are then operated on by polarization dependent devices 532 and 534, which may be two similar polarization dependent devices, such as crosspoint switches, SOAs, or other PIC devices. One of the polarization streams, optical stream 540, is rotated ninety degrees by polarization rotator 542, while optical stream 536 is propagated without polarization rotation. These optical streams are then combined by polarization combiner 546, to produce optical stream 548. Optical stream 548 may be rotated by polarization rotator 550 to yield output stream 552, which has the same polarization as input optical stream 522.

Polarization splitting and combining may be carried out on a per-switching stage basis to avoid balancing optical path lengths between fiber and polarization maintaining fibers and connectors. At 100 Gigasymbols/s (Gs/s), to maintain polarity phase alignment of 10% of a clock cycle, the path lengths for the two polarizations are balanced to within 0.2 mm. For 25 Gs/s (for example a 100 Gb/s signal sent on four parallel optical carriers) and 10% of a clock cycle, the two polarizations are balanced to within 0.8 mm. In other examples, the polarization paths are balanced within a distance determined by the acceptable level of inter-symbol overlap to control inter-symbol interference (5-30%) and symbol rate (10 Gs/s to 100 Gs/s). In some examples, the polarization paths are within 5 mm, 1 mm, 500 μm, 200 μm, 100 μm, 50 μm, or another distance.

A polarization splitter/combiner may be integrated on PIC chips or optical macromodules. It is desirable to have low optical losses, low impairments, low nonlinearity, and low noise. Also, it is desirable for accurate orthogonal splitting matching in the optimum polarization plane for the PIC and to rotate and split the polarization of the orthogonal component into this plane. This may be applied to each switching stage to avoid polarization maintaining interconnect between stages. The use of polarization splitting and rotation at the inputs to the first switching stage and polarization rotation and combining at the output stage reduces optical loss, doubles the amount of optical interconnect inside the switch, utilizes polarization maintaining connections and paths through the entire fabric, and demands tight differential path length control, for example less than or much less than 1 mm, over the paths through the switching path.

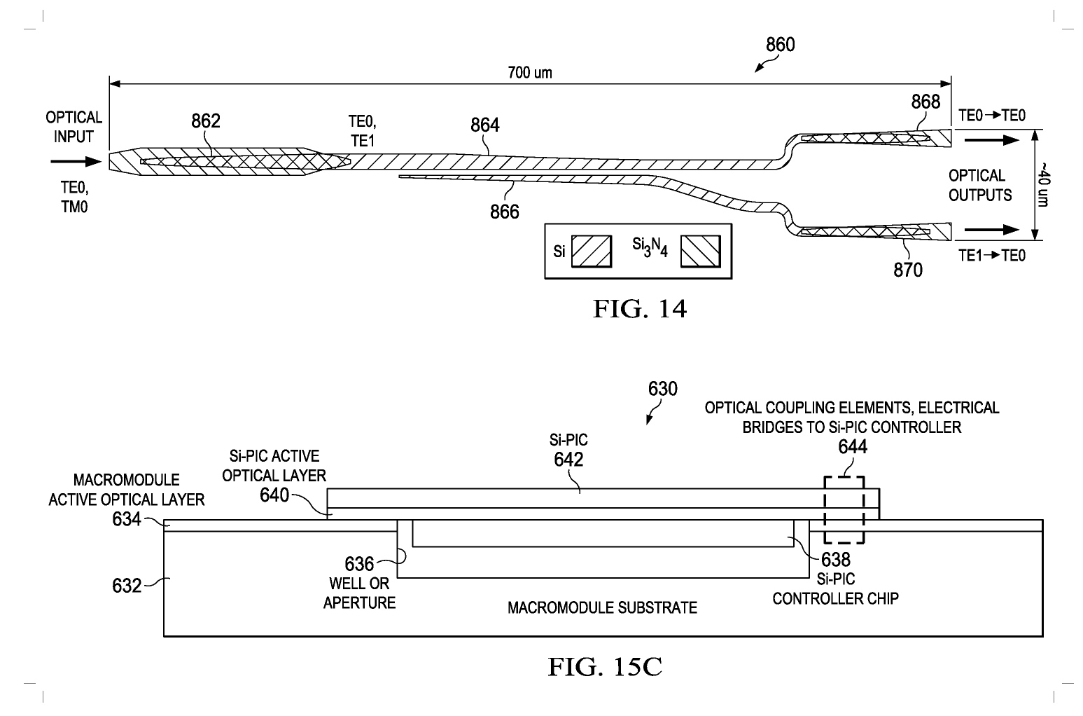

Multiple designs and methods for integrated polarization splitters may be used. One example silicon nitride on silicon-on-insulator (SOI) polarization splitter based on TM0-TE1 mode conversion, such as waveguide 860 illustrated in FIG. 14, may be used. Regions 862, 868, and 870 are made of silicon nitride, while regions 864 and 866 are made of silicon. The device creates two similarly polarized streams from the orthogonal components of an incoming optical stream. A polarization splitter rotator may be integrated within the macromodule substrate. It may be about 700 μm in length and about 40 μm wide, for an area of about 0.028 square mm so 128 of these occupy an area of about 3 square mm. In another example, an expanded form is used to match the lithographic processes of the macromodule substrate, so the 128 devices are incorporated into the macromodule substrate using between about 5 square mm and 15 square mm—a small percentage of the 1225-13924 sq mm of the optical macromodule substrate.

In an optical macromodule, there may be a silicon or silica on silica optical interconnect structure, which in examples, may be between about 35 mm and about 118 mm per side. The substrate provides the optical interconnect into, out of, and between devices hybridized on the surface of the optical macromodule using a combination of waveguide technologies and topologies, including quasi-single mode waveguides between devices, which reduce losses. In one example, there is little or no mode conversion during the transit on longer macromodule optical paths. The optical macromodule substrate may provide some monolithic photonic functionality within the substrate, for example waveguide based optical power splitters and combiners and polarization splitters and combiners. The waveguides in the substrate may be coupled optically into hybridized devices and into incoming and outgoing optical connections. Hybridized devices may be coupled into using close waveguide couplers, diffraction grating couplers, angled micro-mirror couplers, or other couplers. Evanescent waveguide-to-waveguide vertical couplers, diffraction grating couplers, micro-mirror couplers, edge couplers, or other couplers may be used to connect to incoming or outgoing fibers. Also, beam mode expanders and compressors may be used to match to outgoing and incoming optical signals.

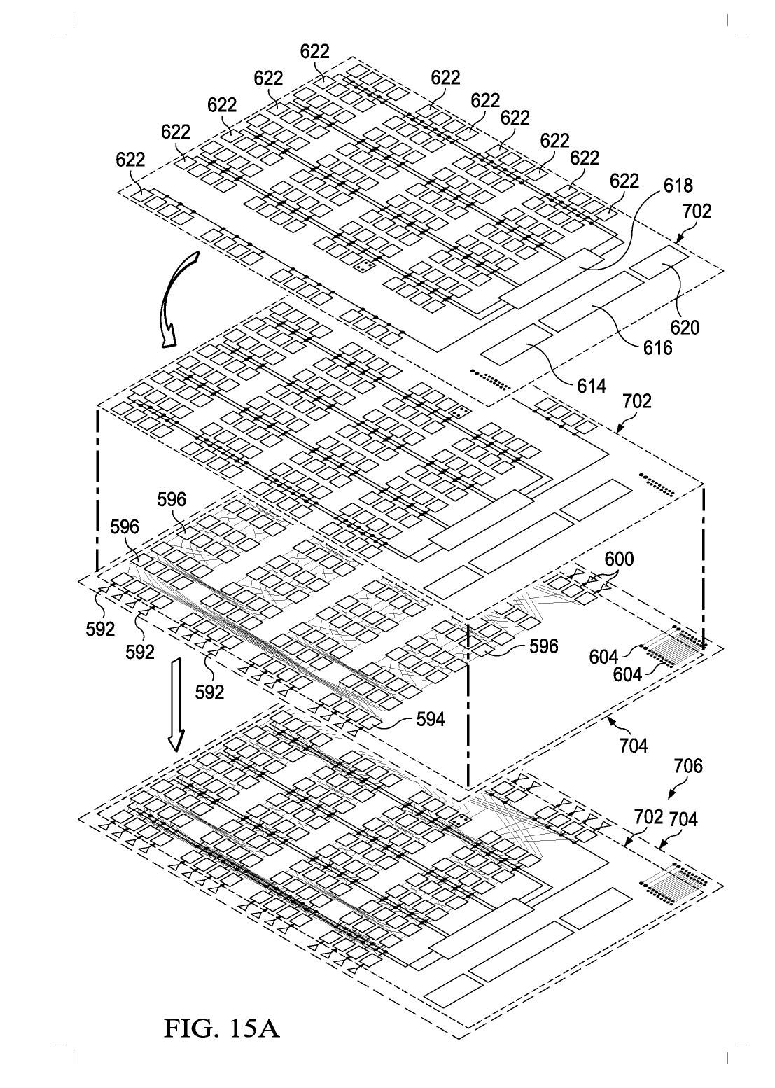

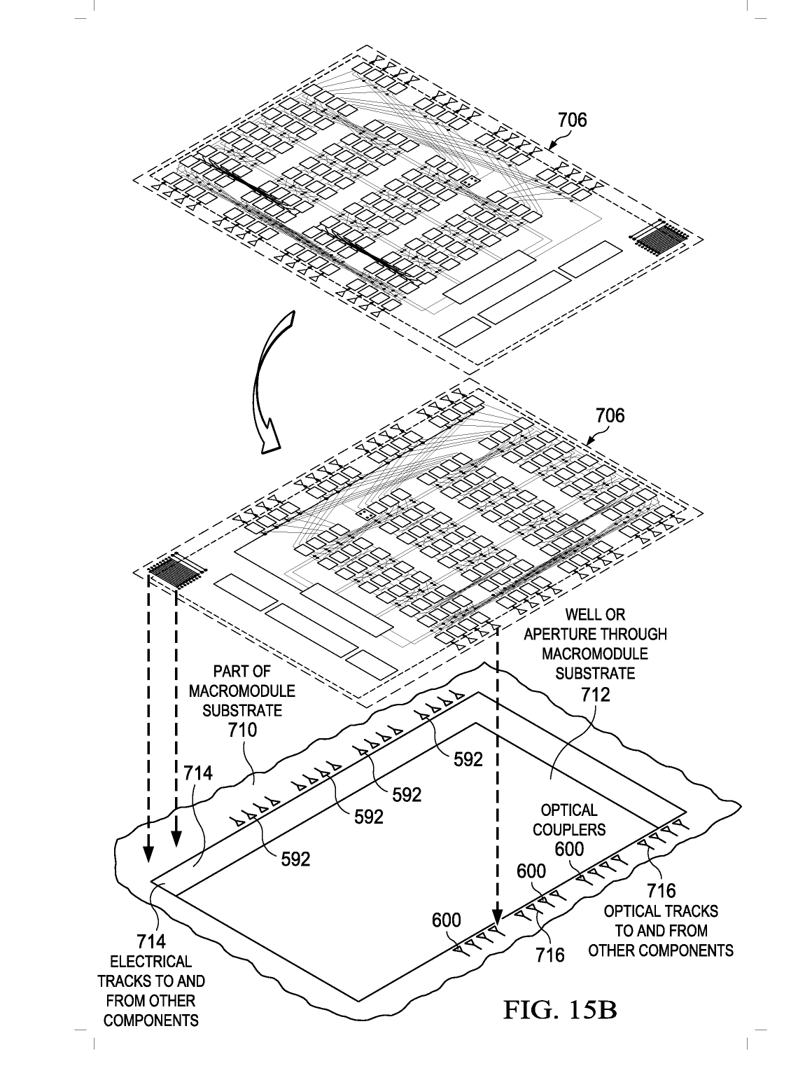

Hybridized photonic devices use electrical power, which may be provided by direct device or macromodule substrate electrical conductor contacts, or by wire bonding between the hybridized device and the macromodule electrical tracks and pads. For some photonic devices, such as PIC switches, the electronic control ASIC is bonded to the optically active surface of the PIC. FIG. 15A shows the process of flipping the control chip 702 with active face up, is inverted and mounted face-to-face on PIC 704, which has its active face up, to form structure 706. FIG. 15B shows the structure 706 flipped to mount in well 712 of optical macromodule 712. The structure has electrical tracks 714 to and from other components and optical tracks 716 to and from other components. FIG. 15C illustrates a cross-section of the resultant optical macromodule configuration 630. PIC controller chip 638 is placed in well 636 of macromodule substrate 632, so the active portion of PIC controller 636 is level with the active portion 634 of optical macromodule 632. PIC 642 is placed with active optical layer 640 next to both controller chip 638 and macromodule active optical layer 634 for direct optical and electrical coupling between the PIC and both the controller chip and the macromodule substrate. This is facilitated by overhang 644 with optical coupling elements and electrical bridges to the controller chip. Connections between the controller chip and the macromodule substrate may be through the PIC.

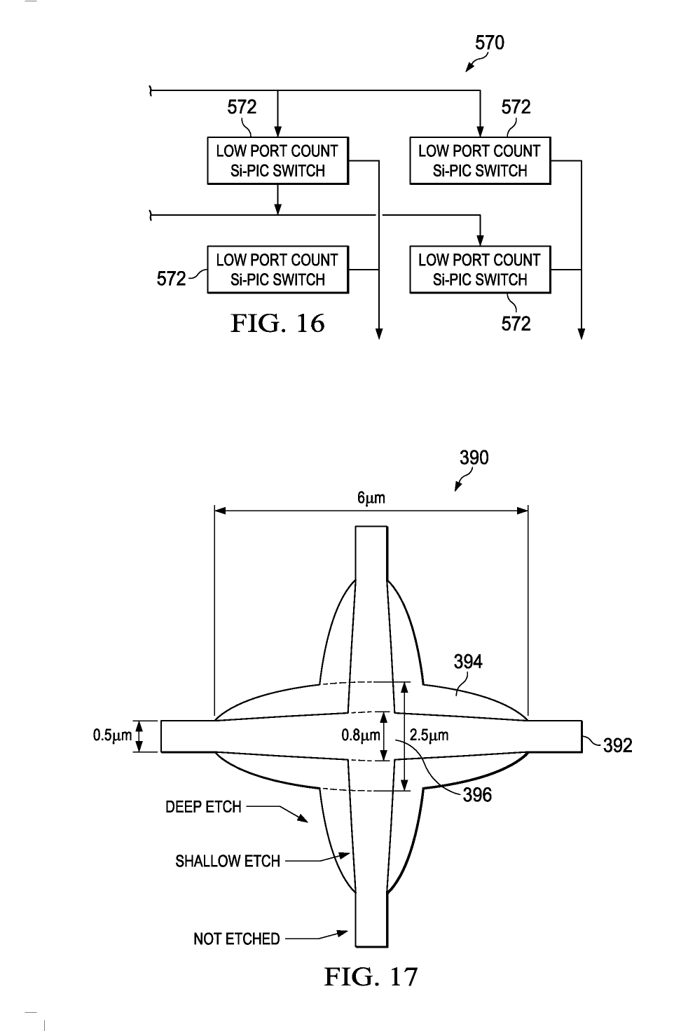

A large photonic switch may be composed of a matrix array of smaller photonic switches. FIG. 16 illustrates photonic switch 570, a matrix of smaller switches, switches 572. The lower port count switches may be, for example 8×8, 8×16, 16×16, or another size photonic switches. A 2×2 array, such as photonic switch 570, increases the throughput of the switch by two times and uses four switches, while a 4×4 array increases the throughput of the switch by four times and uses 16 switches.

With a space-space-space three stage switch, the control system for photonic switching structure 100 may be similar to that in U.S. patent application Ser. No. 14/455,034. However, the control system also includes a center stage controller (CSC), which collects the input stage outputs selected for the paths and the output stage inputs for the same paths and maps them to the center stage input to output mapping for each center stage switching module.

A substrate material for an optical macromodule may be silicon or silica on silicon. Silicon or silica may be amenable to the fabrication by lithographic means of high density optical waveguide traces with low loss and low crosstalk at waveguide crossings. FIG. 17 illustrates waveguide crossing 390 with a low diffraction loss from a low index contrast. Photonic wires 396 and parabolic mode expanders 394 are etched with a double edging scheme for reduced crosstalk. Also, functions such as power splitters, power combiners, polarization splitters, and polarization combiners may be integrated into the substrate. Additionally, optical amplifiers, such as EDWA amplifiers, may be integrated in the optical macromodule. Also, the substrate may have electrical traces for hybridized optical and electrical components. Another material system besides silicon may also be used.

The macromodule substrate supports a very dense set of optical interconnects with low loss and facilitate waveguide crossings with low loss. There is also coupling both into and out of the substrate both to hybridized devices and external connectors. The on substrate optical interconnect includes very dense single mode waveguides with large numbers of inputs and outputs for the hybridized PICs to be connected to the photonic signal sources and destinations within the optical macromodule and with optical coupling between the substrate waveguides and the hybridized components, and between the waveguides and external optical connections. There may be closely spaced single mode waveguides with relatively low loss on the longest paths. Waveguides cross other individual waveguides and large groups of other waveguides without significant loss or crosstalk. The waveguides terminate by coupling out of the substrate or into it or into or out of hybridized components with large number of connections and/or one or two optical connections. The optical signals are connected to and from the substrate from optical connectors. Mode expanders and compressors may be used to convert between the tightly confined modes of the on substrate waveguides and the broader modes of a fiber system.

On substrate electrical interconnect may be provided using aluminum or copper tracking. Electrical connects cross each other, which may use a two layer metallization scheme with an insulating material such as SiO₂, Al₂O₃, a polymer, or another insulating material between the tracks. Electrical signals and power may be wire bonded on the substrate electrical tracks using pads.

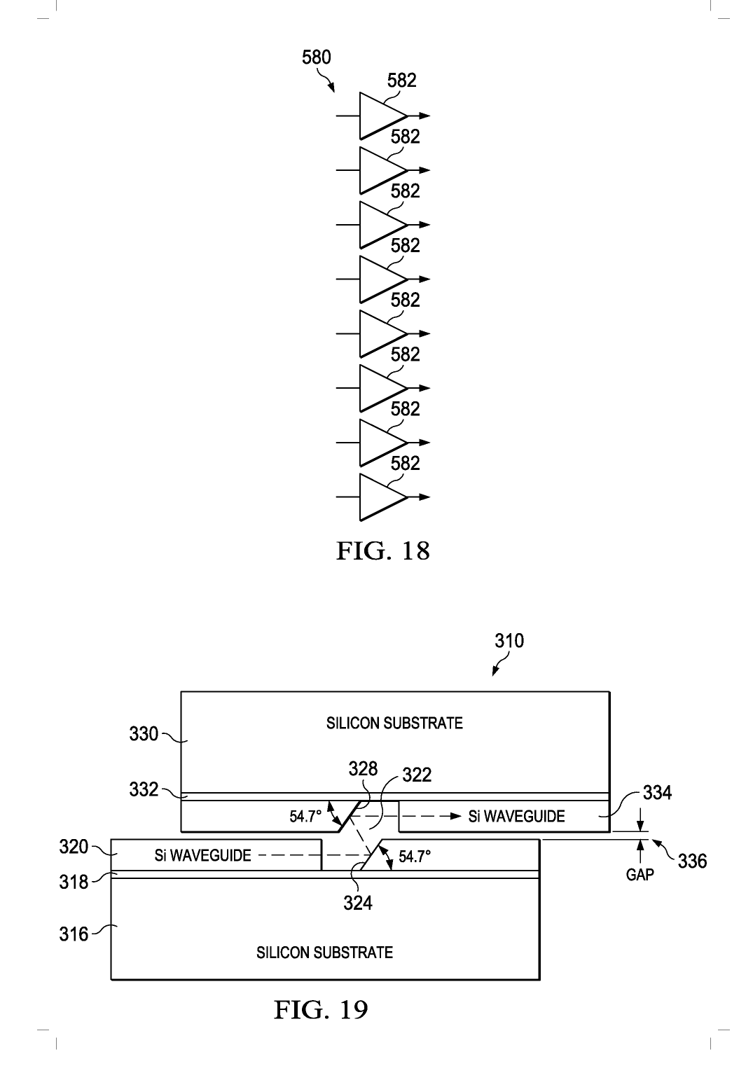

There may be a variety of hybridized components on the optical macromodule, including PICs, such as optical switches, with large numbers of optical inputs and outputs, and SOAs. FIG. 18 illustrates SOA array 580 with SOAs 582. Also, ASICs may be hybridized for control of the PICs, and other ASICs, such as an overall macromodule control and interface ASIC, and SOA gain control ASICs, may be used. Optical connections may include fiber attached and expanded beam attached, as well as other forms of optical connections. Also, in some examples, high power EDWA pump lasers may be hybridized. Alternatively, the EDWA pump lasers are mounted remotely, where their waste heat may be better dealt with, avoiding heating the optical macromodule, the pump light being injected by fiber, and an integrated pump light optical splitter. Other components which may be hybridized on the optical macromodule include wavelength division multiplexing (WDM) multiplexers and demultiplexers, WDM routers, tunable filters, controllable attenuators, low port count fast photonic switches in other material systems besides Si, lasers, optical detectors, electro-optic functions, and integrated circuits. For the hybridized components, coupling between the components and the substrate exhibits optical loss, which may be offset by optical amplification.

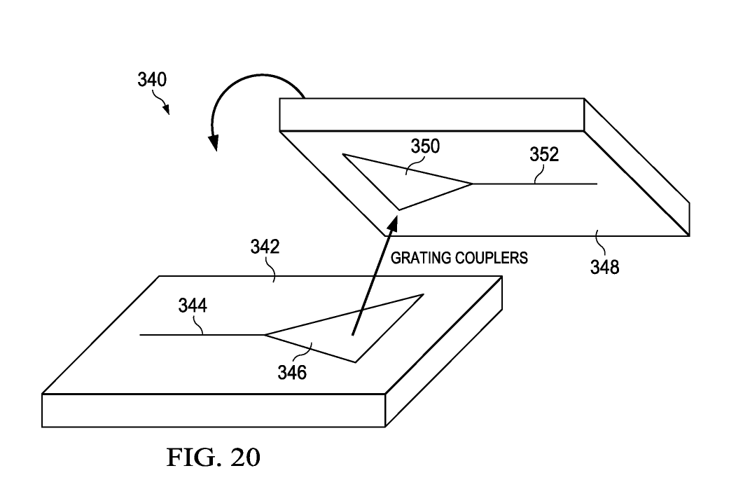

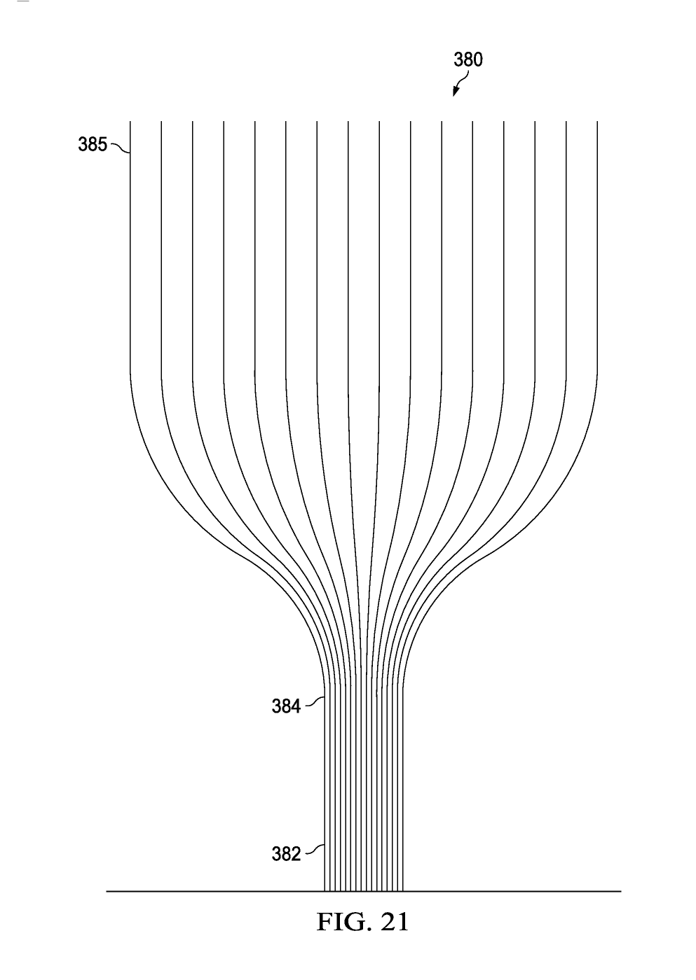

The hybridized components are mounted with physical, optical, and electrical coupling to the macromodule substrate. Physical mounting and bonding may be used at the surface of the optical macromodule, for example by electrical connections such as solder bumps, or by glue bonding. Optical connections may be by arrays of couplers between the optical macromodule and the hybridized components, such as evanescent waveguide-to-waveguide vertical coupling, grating coupling, and/or micro-mirrors, which may be established in a fixed spatial relationship, so the hybridized components are aligned. FIG. 19 illustrates micro-mirror coupler 310. Silicon waveguide 320 is on insulator layer 318 on silicon substrate 316, while silicon waveguide 320 is on insulator layer 332 on silicon substrate 330. Light from waveguide 320 enters air space 322 and impinges on mirror 324, which is at a 54.7 degree angle from the structure of the material. This angle may have other values which are matched between both surfaces. The light is reflected to mirror 328 into waveguide 334. There may be a gap 336 between the upper surface of Silicon substrate 316, which forms the optical macromodule, and the lower surface of silicon substrate 330, which forms the PIC. This gap may be filled with a bonding agent such as an optical epoxy, or may be an air gap with PIC to macromodule bonding achieved by other means, such as multiple micro solder bumps, which also provide the electrical connection. Alternatively, the gap may not be present. The effect of the gap on device alignment depends on the actual angle of the mirror—the closer it is to 45 degrees the less the effect of variations in the gap affecting the beam alignment to the micromirror. FIG. 20 illustrates an example of a grating coupler, grating coupler 340. SOI chip 342, representing the macromodule substrate, is placed face to face with SOI chip 348, representing the PIC or other hybridized component being mounted to the optical macromodule. Light propagates along waveguide 344 to grating coupler 346, which is placed close to grating 350. The diffraction grating couplers are used with a diffraction grating, creating an output beam at an angular offset to normal to one of the surfaces to be coupled from, and a receiving diffraction grating tuned to the same angle to recover the incoming beam and couple it into the waveguide on the other surface. The emitted light from grating 346 is coupled through grating 350 to waveguide 352.

Two or four additional couplers and a path through the hybridized components between the pairs of couplers may be used for optical signals to be passed from the optical macromodule through the hybridized component and back to the optical macromodule for active alignment of the hybridized components to the optical macromodule. Electrical connections may be direct solid connections, such as solder bumps or indirect methods, such as wire bonding. The hybridized components are aligned for optical coupling between the optical macromodule optical interconnect and the hybridized optical components via optical couplers with matched closely coupled waveguide stubs, with one waveguide per stub in the substrate and the other stub on the hybridized components, which are mounted in close proximity.

Optical connections into and out of the optical macromodule may use edge coupled connectors or waveguides/fibers, waveguide mode expanders and expanded beam connectors, for example graded refractive index (GRIN) lenses. FIG. 21 illustrates waveguide mode expander 380, which also increases the waveguide pitch. Members of a set of narrow waveguides 382 are expanded to wide waveguides 385 using adiabatic region 384, an expansion region where the waveguide cross-section slowly increases and the spacing between waveguides also slowly increases to create a coarse pitch at the expanded end to match the connector/off-macromodule link spacing while achieving a tight spacing and small mode field size at the PIC, for coupling into that PIC. Precision alignment of the optical coupling between the hybridized components and the optical macromodule is done with lithographically fixed locations. Test locations or paths may be used in the hybridized component and the optical macromodule to facilitate optical signal(s) being passed through the macromodule-PIC-macromodule to adjust the alignment of the hybridized component on the macromodule surface before bonding. This process may be automated for automatic mounting and optimization of hybridized components on the macromodule surface.

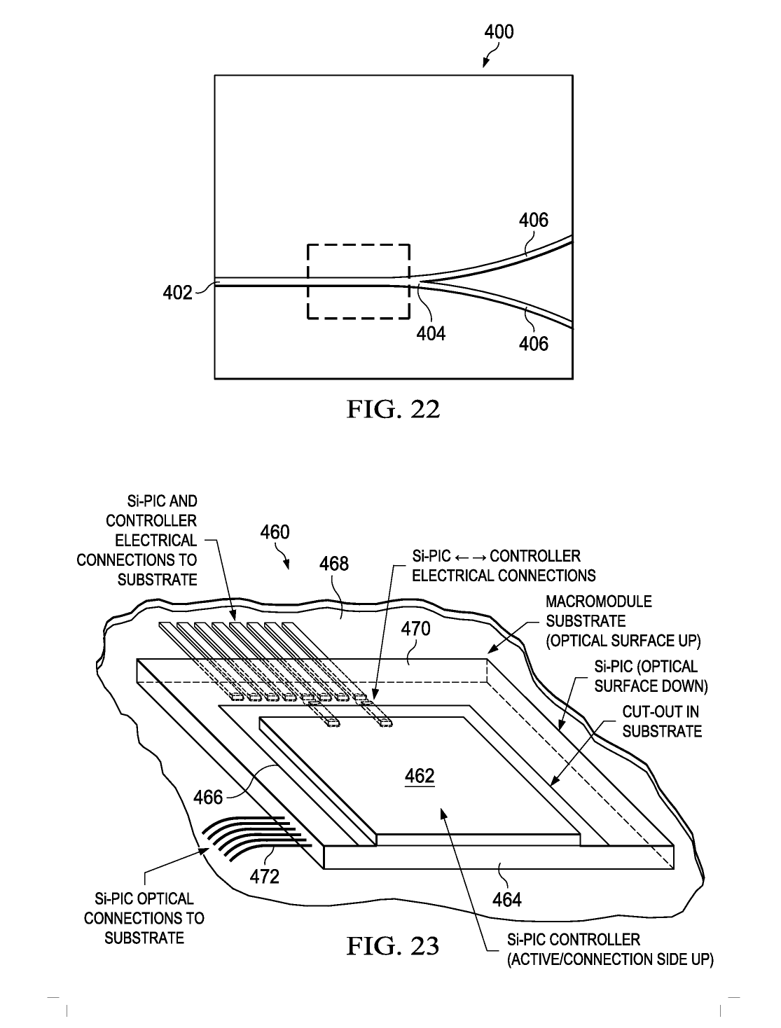

A variety of monolithic functions and components are integrated in the macromodule substrate. Some monolithic functions include waveguides and arrays of waveguides with low loss. Other monolithic components include couplers into and out of waveguides at the hybridized components, mode expanders and compressors between the waveguides and fibers or external connectors, and waveguides or waveguide arrays which cross other waveguides or waveguide arrays. FIG. 22 illustrates an example optical power splitter 400. An optical stream is split from one stream in waveguide 402 to two streams in waveguides 406 at 404. Additional monolithic functions may include optical power splitters and combiners, optical polarization splitters, combiners, EDWAs, and couplers into and out of the EDWAs for coupling of pumped light at 980 nm. Some functions may be either monolithic, hybridized, or a combination.

The PIC chips are associated with per-cell switch controllers for cell optimization to maximize the contrast between on and off states and/or cross and bar states. The control may be intimately connected to the PIC, for example by mounting it over the PIC with the surface of the controller picking up on the surface of the PIC to control the individual cells. A hole or cut out may be placed in the optical macromodule under the PIC so the control chip is mounted on the hole with its active surface picking up on the PIC chip it controls. The control chip may be tracked out electrically for power, ground, inputs, and outputs by electrical tracks. The controller may also be thermally connected to the mounting plate under the optical macromodule.

Thermal management, such as heat sinking, may be used, especially with SOAs. SOAs may burn up to 0.5 W of electrical power when continuously operated at the gain, so an array of 64 SOAs on the surface of an optical macromodule may burn up to 32 W. This creates a cooling challenge in the optical macromodule. However, because the SOAs are associated with specific PIC output ports, and may be powered up in ˜500 picoseconds, each SOA of a SOA array may only be powered when its associated PIC output port is being used. This may be facilitated by coupling the SOA controller to the PIC controller, so the PIC controller provides frame-by-frame information on which output ports will be used. In a dilating switch stage, this reduces the peak power by a factor of two, even when all inputs to the PIC are 100% occupied all the time. At the packet switch overload point where momentary loads reach 100%, the average load is around 30%, resulting in a further factor of 3.3 saving because the thermal time-constant of the SOA plus cooling system mass is multiple orders of magnitude longer than the frame time, and therefore thermally integrate the effects of the frame-by-frame power burn. For a non-dilated switch, the number of SOAs is halved, and approximately 3.3:1 average power saving is achieved. At normal operating loads in a data center, with an average traffic level of around 10% (peak around 30-40%), where the packet switching delay starts to rise from the level of packet collisions triggering retransmission, the power saving is around 10:1. Also, SOAs are thermally sensitive, and perform better when cool. In another example, EDWAs are used, where electrical power is consumed by an external pump laser, which may be cooled externally, avoiding injecting waste heat into the optical macromodule system.

PICs may have fine tolerances in small areas, while larger geometry devices have wider tolerances. Local registration features and capabilities may be used for precisely placing the PICs. Also, placement-tolerant coupling may be used at the PIC macromodule interfaces.

FIG. 23 illustrates a zone within optical macromodule 460 with macromodule substrate 468 having its optically active surface oriented up. PIC 464 is mounted on macromodule substrate 468 with its optically active surface down to facilitate optical coupling between the PIC and the macromodule substrate by optical connections 472 and electrical coupling with electrical connections 470. PIC controller 462 is in well 466 of macromodule substrate 468 with its active or connection side up to facilitate electrical connections 470 to PIC 464. This implements the structure shown in cross-section in FIG. 15C.

In addition to inter-symbol interference caused by skew between the polarization-separated path length differences, a second skew problem exists across the overall switch: frame skew. This frame skew problem arises from the extremely short frame times used. The output data streams from each output port contain packet containers or packets with a short frame time and a very short inter-container or inter-packet gap, which may be about a nanosecond or two. The output stream contains containers or packets from multiple inputs, depending on the frame-by-frame switch cross-connection map, where each container or packet is selected by the switching process. Control loops back to the container or packet source peripherals facilitate that the containers or packets are accurately time-aligned to the switch frame at the switch inputs. Thus, if all the switch paths from all inputs to any output had zero propagation delay, the output container or packet stream would include containers or packets with the correct inter-container or inter-packet gaps, and would be aligned to the switch input frame. A fixed common amount of delay on the switch paths would cause the output to be offset in timing from the input, but the inter-container gap or inter-packet gap would not change, because the paths would have the same delay. However, if the individual path lengths through the switch are different, these path length differences lead to modulation of the inter-container gap or inter-packet gap, which may result in a reduction of the inter-container gap or inter-packet gap to the point where the destination TOR cannot distinguish the individual containers or packets or two adjacent containers or packets partially overlap each other. The tolerances may be a few centimeters across all paths within the switch, and are generated by the total path length across the switch, including the inter-macromodule interconnect. The optical macromodule may lithographically control its path lengths and to be approximately matched. However, the inter-macromodule interconnect is outside the optical macromodule. A low skew packaging and interconnect approach at the fabric level reduces skew for a fast frame time. Additional details on a packaging and interconnect scheme are further discussed in Patent Application Docket Number HW 91029929 filed on May 12, 2015, and entitled “System and Method for Photonic Structure and Switch,” which this application incorporates hereby by reference.

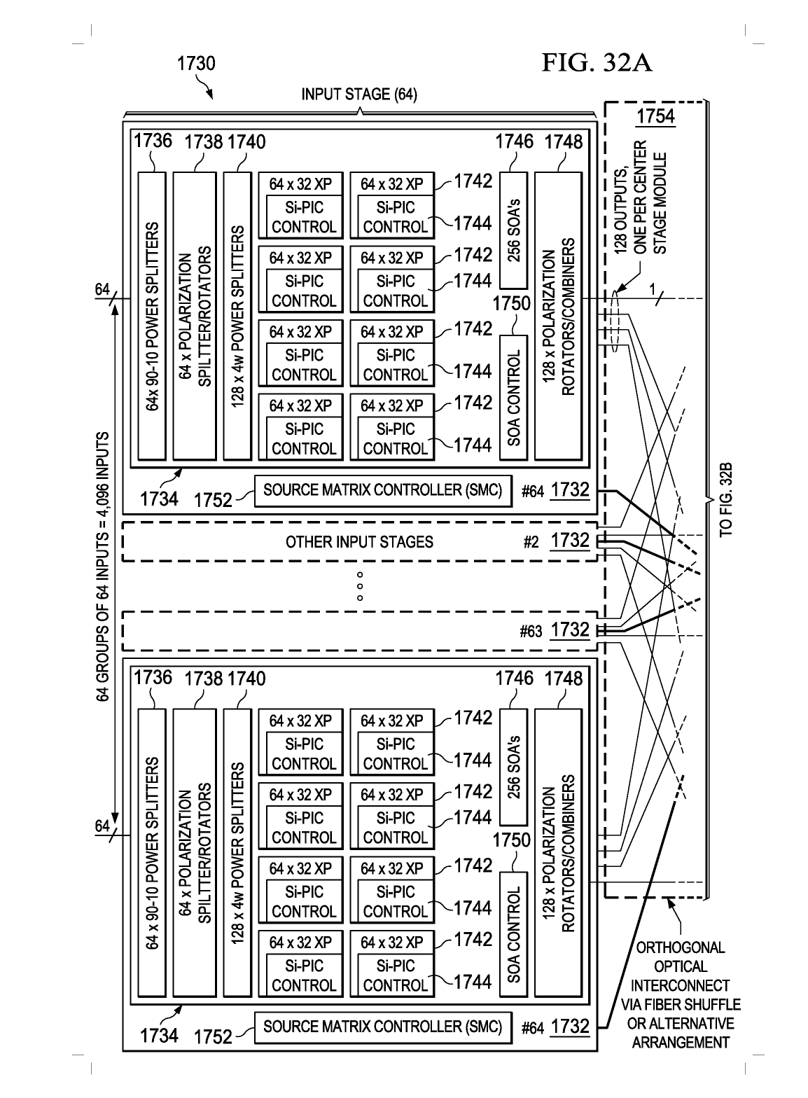

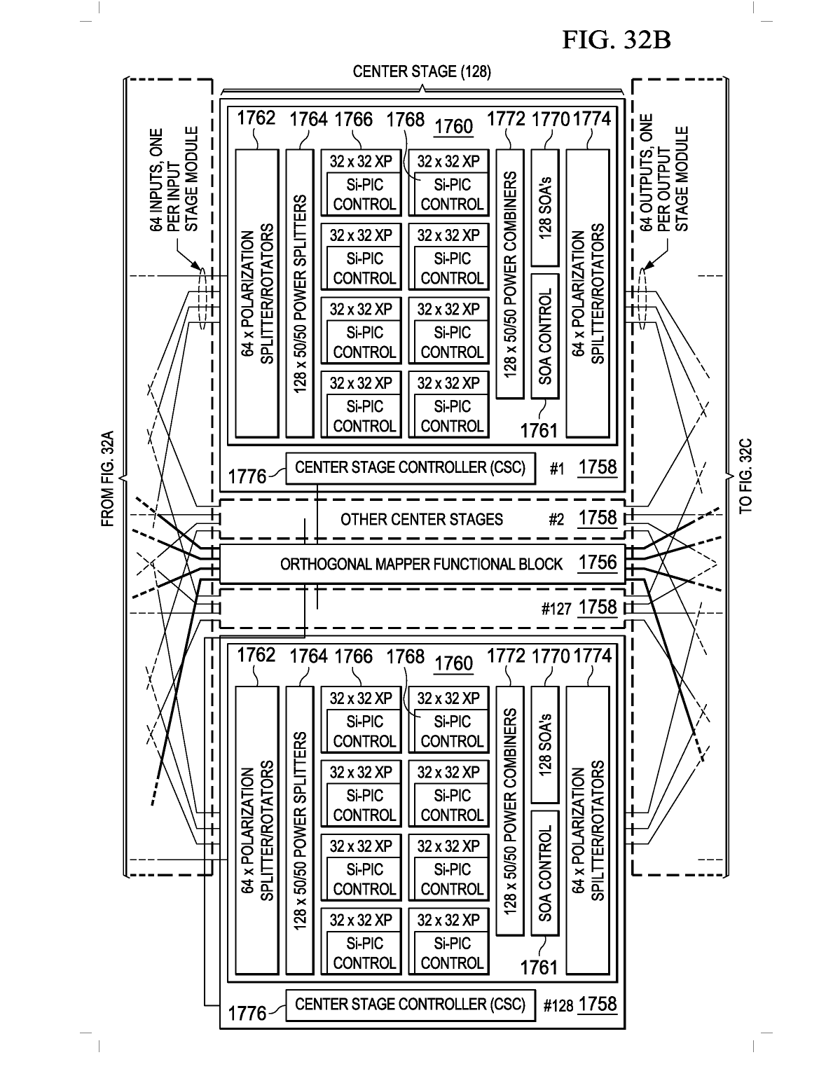

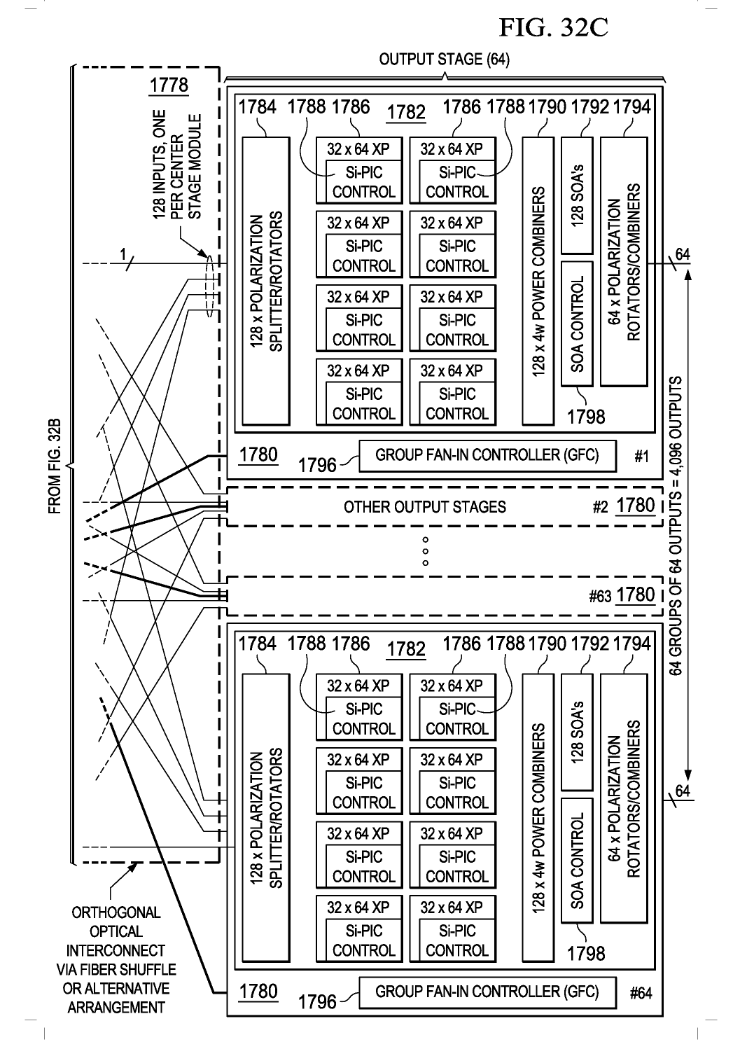

Table 2 shows an overview of several example photonic switch fabrics with optical macromodules. The 4096×4096 polarization-agnostic switch of FIG. 32 may be implemented with 32×32 PICs by increasing the input stage macromodule array to 2×4 and the output stage macromodule array to 4×2 to move the dilation from the PIC into the optical macromodule.

TABLE 2

| Switch | Dila- | | | Macromodule |
|---|---|---|---|---|
| Size | tion | Polarization | PIC Capacity | Array Size |
| 256 × 256 | 1:2 | Polarization | 16 × 32, 16 × 16 | 1 × 1, 1 × 1, |
| | | Agnostic | | 1 × 1 |
| 1024 × 1024 | 1:2 | Polarization | 16 × 32 | 2 × 2, 2 × 1, |
| | | Agnostic | | 2 × 2 |
| 1024 × 1024 | 1:2 | Single | 16 × 32 | 2 × 2, 2 × 1, |
| | | Polarization | | 2 × 2 |
| 1024 × 1024 | 1:2 | Polarization | 32 × 32 | 1 × 2, 1 × 1, |
| | | Agnostic | | 2 × 1 |
| 1024 × 1024 | 1:2 | Single | 32 × 32 | 1 × 2, 1 × 1, |
| | | Polarization | | 2 × 1 |
| 2048 × 2048 | 1:2 | Polarization | 32 × 32 | 1 × 2, 2 × 2, |
| | | Agnostic | | 2 × 1 |
| 2048 × 2048 | 1:2 | Single | 32 × 32 | 1 × 2, 2 × 2, |
| | | Polarization | | 2 × 1 |
| 4096 × 4096 | 1:2 | Single | 32 × 32 | 2 × 4, 2 × 2, |
| | | Polarization | | 4 × 2 |
| 4096 × 4096 | 1:2 | Polarization | 64 × 32, 32 × 32 | 2 × 2, 2 × 2, |
| | | Agnostic | | 2 × 2 |

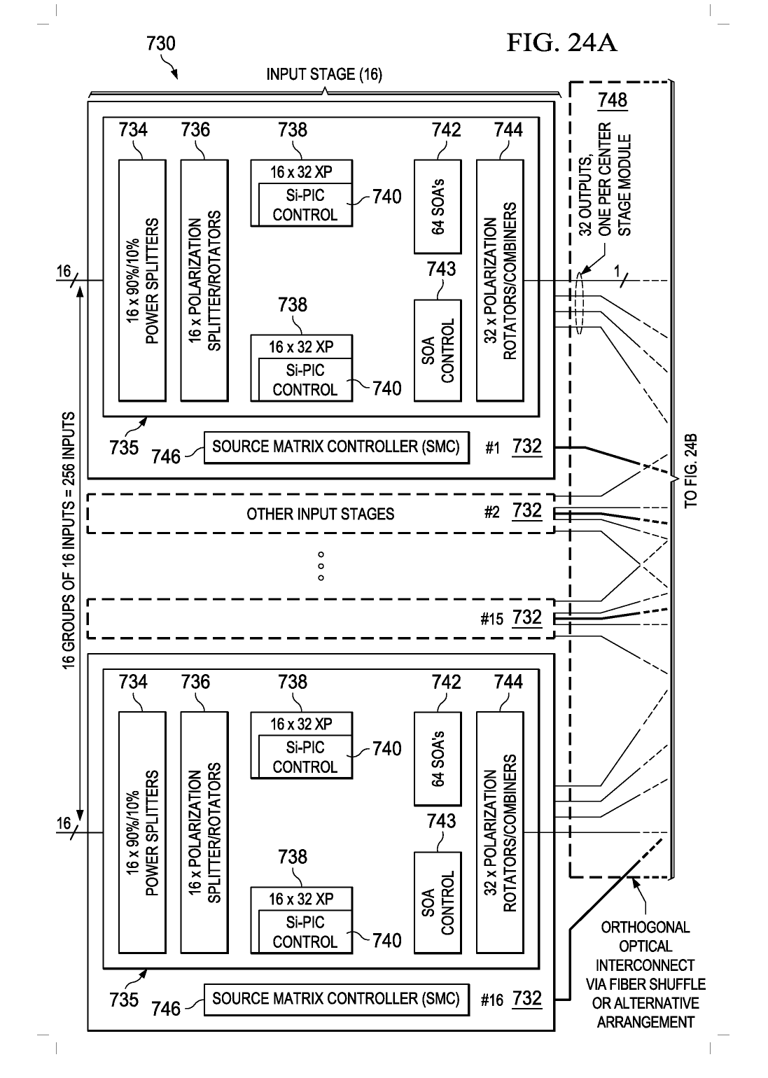

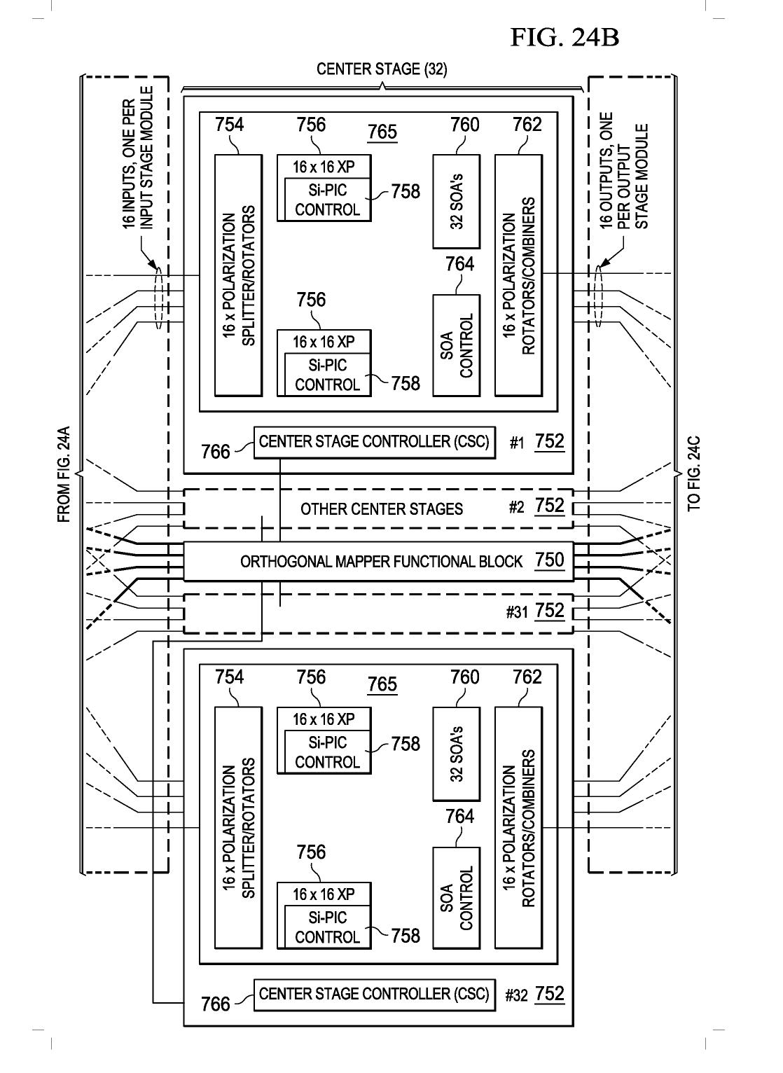

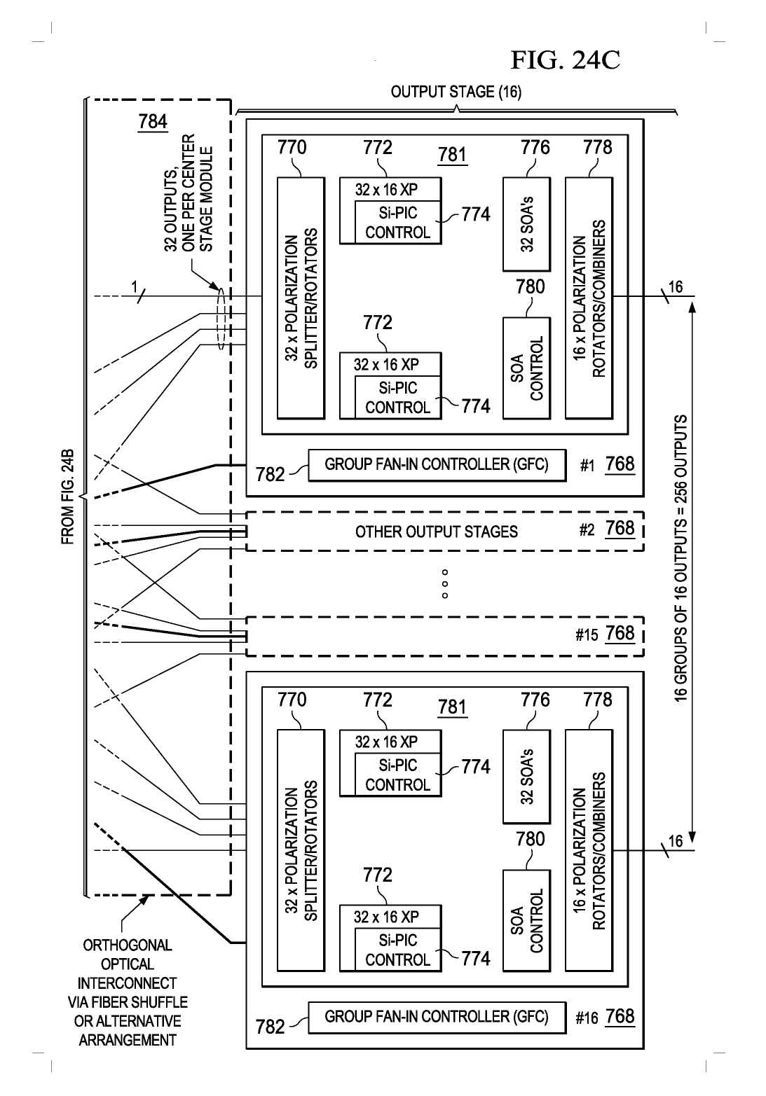

FIGS. 24A-C illustrate photonic switching system 730, a 256×256 photonic switch with 1:2 dilating which is a polarization agnostic low loss photonic fast circuit switches with distributed parallel pipelined real time control using 16×16 and 16×32 PIC matrices. A control system, such as the control system disclosed in U.S. patent application Ser. No. 14/455,034 may be used. The switching packet is formed from single polarized 16×32 or 32×16 PICs and 16×16 PICs in a three stage structure, including input stages 732 (16 input stages), center stages 752 (32 center stages), and output stages 768 (16 output stages). The stages have unity macromodule capacity gain.

An input stage contains power splitter 734, 16 90:10 power splitters, which provide a low level of about 10 dB to about 12 dB below the input signal to the phase detector, while most of the optical power (1 dB to 1.5 dB power reduction) is passed to polarization splitter/rotator 736, 16 monolithic polarization splitters. The phase detector detects the alignment of the incoming containers to be switched with reference to the timing of the internal fabric framing clock, and generates a correction signal based on that misalignment, which is fed back to the source TOR output circuits to correct their timing, so the container received at the switch are aligned to the switch frame. The component of light passed to polarization splitter/rotator 736 is separated into two polarization planes, one of which is aligned to the PIC, and the other component orthogonal to this polarization. The orthogonal component is then rotated 90 degrees into the same plane as the first portion, leading to two optical streams with the polarization for the accurate operation of the PICs. These two optical streams are switched by silicon crosspoint switches 738, 16×32 crosspoint switches, which are controlled by PIC controllers 740. Because the switches are rectangular, they introduce 1:2 dilation. The signals are then amplified by SOAs 74, 64 SOAs, which are controlled by SOA controller 743. The SOA controllers may be fed port usage information from the PIC controllers so for real time switching of the SOAs and power consumption control and optical gain control. The amplified streams are then combined by polarization rotators/combiners 744, 32 polarization rotators and combiners. One stream is rotated ninety degrees, and then the two streams are combined, for a composite polarization agnostic output. The macromodule trace lengths may be equalized in pairs to reduce polarization skew. The macromodule trace lengths may also be more approximately globally equalized to contribute to controlling switch output port inter-container skew. Power splitters 734, polarization splitters/rotators 736, PICs 738, SOAs 742, and polarization rotators/combiners 744 are in an optical macromodule 735, along with PIC controllers 740 and SOA controller 743.

The PIC connectivity map is uploaded every frame from source matrix controller (SMC), which configures the PICs. With a directly addressable PIC, this involves controlling ever cell. On the other hand, in an indirectly addressable PIC, this involves converting the input connection map from the SMC into a cell-to-cell connection map for the PIC and applying that map to every cell in the switch. In both cases, the PIC controller is intimately connected with the PIC chip it is controller. For example, the PIC chip controller may be mounted face-to-face with the PIC chip it controls, so the optically active face of the PIC chip is bonded electrically to the active connection surface of the PIC controller chip. A well may be created in the optical macromodule substrate to accommodate the PIC controller while providing for electrical connections between the optical macromodule and the PIC controller via the PIC chip being controlled.

An SOA controller may be used to regulate the SOA current to vary the SOA gain, for example to adjust the gain to produce a specific average loss across the optical macromodule. The SOAs may be in an array or multiple smaller arrays rather than as discrete chips. These arrays draw a lot of power and produce heat, and may be cooled. SOAs may be rapidly turned on and off, for example in 500 ps, which may be less than the inter-packet gap (IPG) or inter-container gap. Because the switching path address is known, and the output ports in use are known for each switched container, only SOAs on the paths connected to active PIC output ports need to be on. Thus, the SOA controller may switch the SOAs on when they have data, and off when they do not. When a dilated switch is operating at 100% capacity, only 50% of the SOAs need to be on, and when the switch is operating at peak average traffic (30% capacity) only 15% of the SOAs are on. This reduces the power by 6:1.

The input stages 732 are coupled to center stages 752 by interconnect 748, an orthogonal optical interconnect which may be a fiber shuffle or another arrangement. A fiber shuffle introduces high path skew, and hence high output skew, which limits the size of the inter-container gap or inter-packet gap, and hence the frame speed. A low skew overall packaging approach removes this source of output skew to achieve the best performance. Additional details on a low skew packaging approach are discussed in Patent Application Docket Number 91029229US01. Each input stage is connected to each center stage. The center states contain orthogonal mapper functional block 750.

A center stage module contains polarization splitters/rotators 754, which create two optical streams at the desired polarization per input optical stream. These split streams are then switched by PIC 756, 16×16 crosspoint switches, which are controlled by PIC controllers 758. The PIC controllers use the output of center stage controller (CSC) 766 to control the PICs. The outputs are amplified by SOAs 760, which are controlled by SOA controller 764. Finally, the two sets of output streams are controlled by polarization rotators/splitters/combiners 762 to produce a composite polarization diverse output. Optical macromodule 765 contains polarization splitters/rotators 754, PICs 756, SOAs 760, and polarization rotators/combiners 762, along with PIC controllers 758 and SOA controller 764.

The outputs from center stages 752 are orthogonally coupled to output stages 768 via optical interconnect 784, which may be via a fiber shuffle or another configuration.

An output stage module contains photonic module 781 and group fan-in controller (GFC) 782, which is used to control the PICs. Optical inputs are received by polarization splitters/rotators 770, 32 monolithic polarization splitters/rotators which output two streams of the desired polarization per input stream. These streams are switched by PICs 772, two 32×16 crosspoint switches controlled by PIC controllers 774, which apply inverse dilation. The switched packet streams are amplified by SOAs 760, 32 SOAs which are controlled by SOA controller 780. Finally, the amplified switched packet streams are combined by polarization rotators/combiners 778, 16 monolithic polarization rotators/combiners to produce the final switched polarization agnostic output.

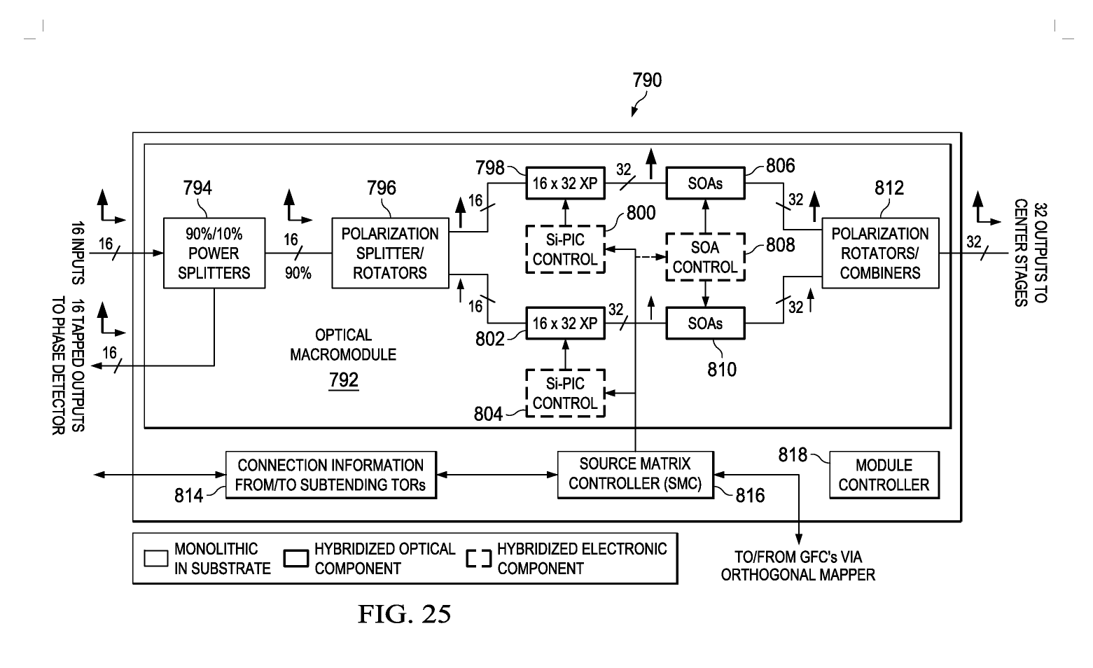

FIG. 25 illustrates input stage 790, an example input stage for a 256×256 polarization agnostic photonic switch, with optical macromodule 792 and electrical components, including module controller 818, connection information block 814, and SMC 816. The optical macromodule includes monolithic elements integrated in the macromodule substrate and hybridized optical and electronic components. Power splitters 794, polarization splitters/rotators 796, and polarization rotators/combiners 812 are monolithically integrated in the macromodule substrate. The hybridized optical components include crosspoint switches 798 and 802 and SOAs 806 and 810, while the hybridized electrical components include PIC controllers 800 and 804 and SOA controller 808.

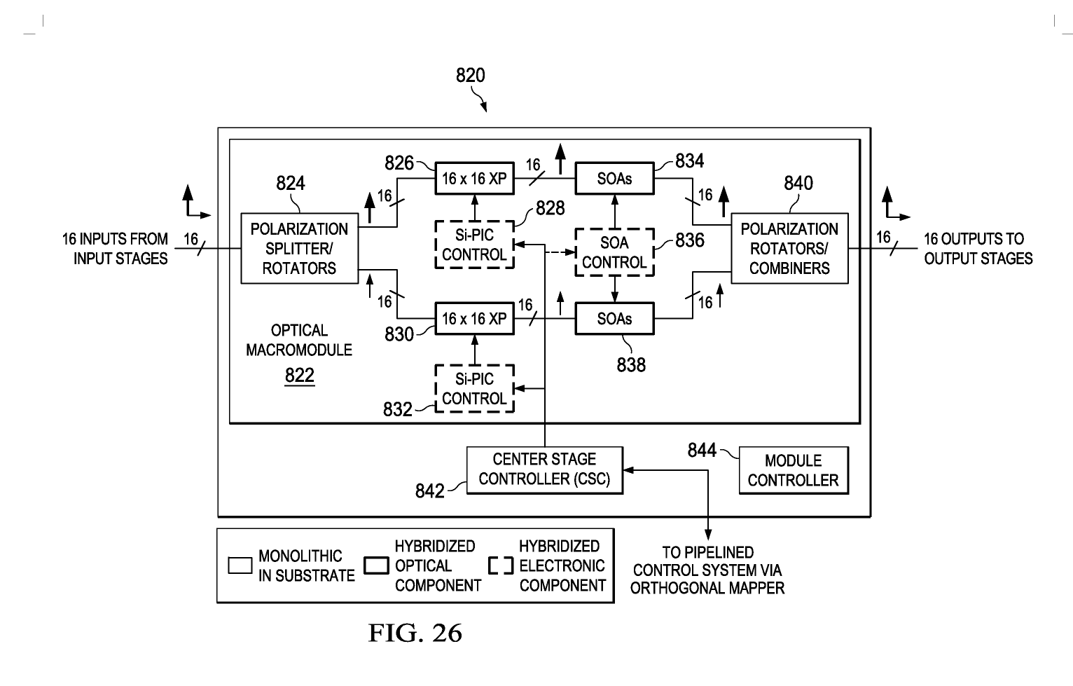

FIG. 26 illustrates center stage module 820, an example center stage module for a 256×256 polarization agnostic photonic switch, which contains optical macromodule 822 and an electronic module with CSC 842 and module controller 844. Optical macromodule 822 includes monolithic components integrated in the substrate, as well as hybridized optical and electrical components. Polarization splitters/rotators 824 and polarization rotators/combiners 840 are monolithically integrated in the macromodule substrate. Also, crosspoint switches 826 and 830 and SOAs 834 are hybridized optical components, and PIC controllers 828 and 832 and SOA controller 836 are hybridized electrical components.

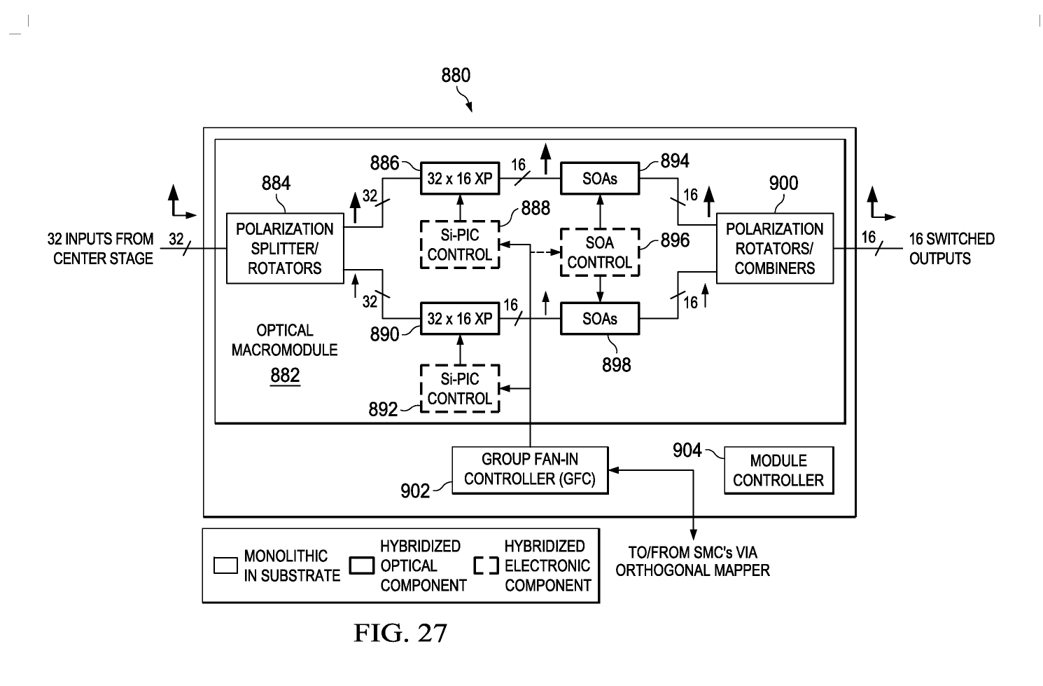

FIG. 27 illustrates an example output switching stage module for a 256×256 polarization agnostic photonic switch, output switching stage module 880, which includes optical macromodule 882 and an electronics module with GFC 902 and module controller 904. GFC 902 coordinates with CSC 842 and SMC 816 to perform pipelined parallel control processes to produce a stream of connection maps, while module controllers 904, 844, and 818 handle provisioning, maintenance, etc. of the overall switching module. Optical macromodule 882 includes hybridized components, including the hybridized optical components crosspoint switches 886 and 890 and SOAs 894 and 898, and hybridized electrical components, include PIC controllers 888 and 892 and SOA controller 896. Additionally, polarization splitters/rotators 884 and polarization rotators/combiners 900 are monolithically integrated on the macromodule substrate.

Table 3 displays an example link budget for a 256×256 polarization agnostic fast switch.

TABLE 3

| Source Of Loss/Gain | Input Stage | | Center Stage | | Output Stage | |
|---|---|---|---|---|---|---|
| Input coupling | 1 | dB | 1 | dB | 1 | dB |
| 90/10 power splitter | 1 | dB | — | | — | |
| Polarization | 3 | dB | 3 | dB | 3 | dB |
| splitter/combiner | | | | | | |
| PIC chip coupling | 4 | dB | 4 | dB | 4 | dB |
| PIC chip losses | 6.3-7.7 | dB | 5.6-7.0 | dB | 6.3-7.7 | dB |
| SOA coupling | 3 | dB | 3 | dB | 3 | dB |
| Macromodule output | 1 | dB | 1 | dB | 1 | dB |
| coupling | | | | | | |
| Total losses | 19.3-20.7 | dB | 17.6-19.0 | dB | 18.3-19.7 | dB |
| SOA Gain to reduce | 14.3-15.7 | dB | 12.6-14.0 | dB | 13.3-14.7 | dB |
| losses to 5 dB per | | | | | | |
| stage | | | | | | |

| | |
|---|---|
| Equalized SOA gain | 13.4-14.8 dB |
| for total 15 dB loss | |
| across switch | |

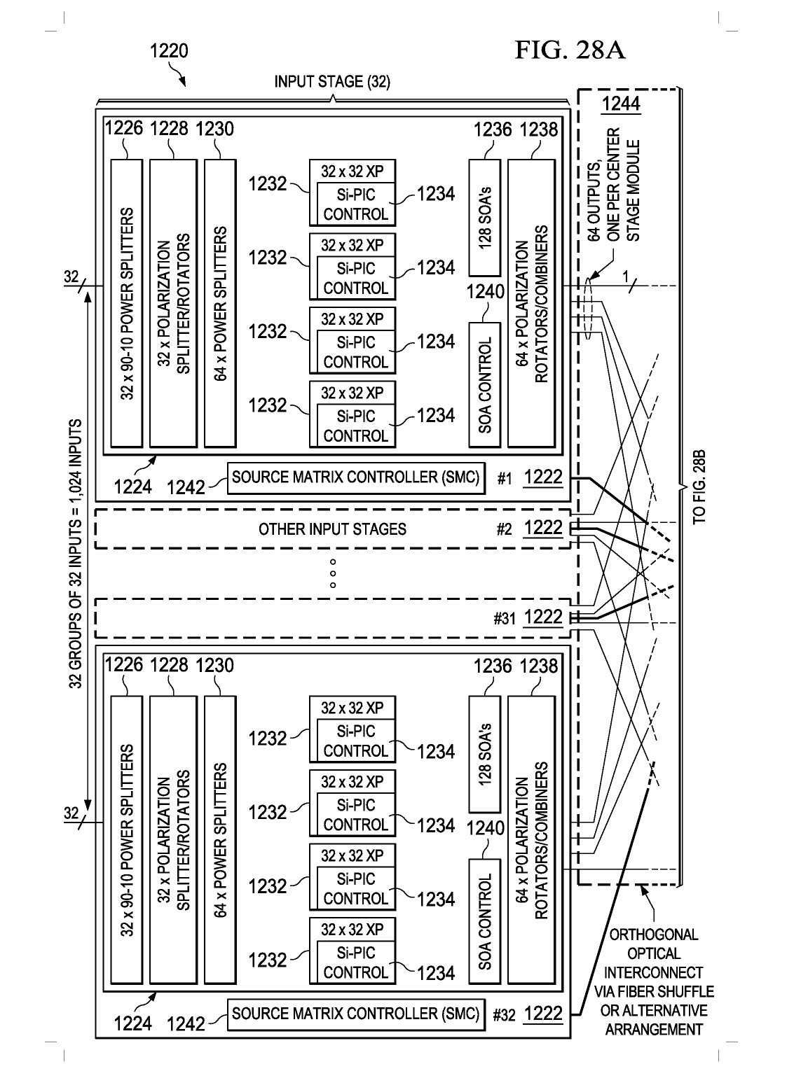

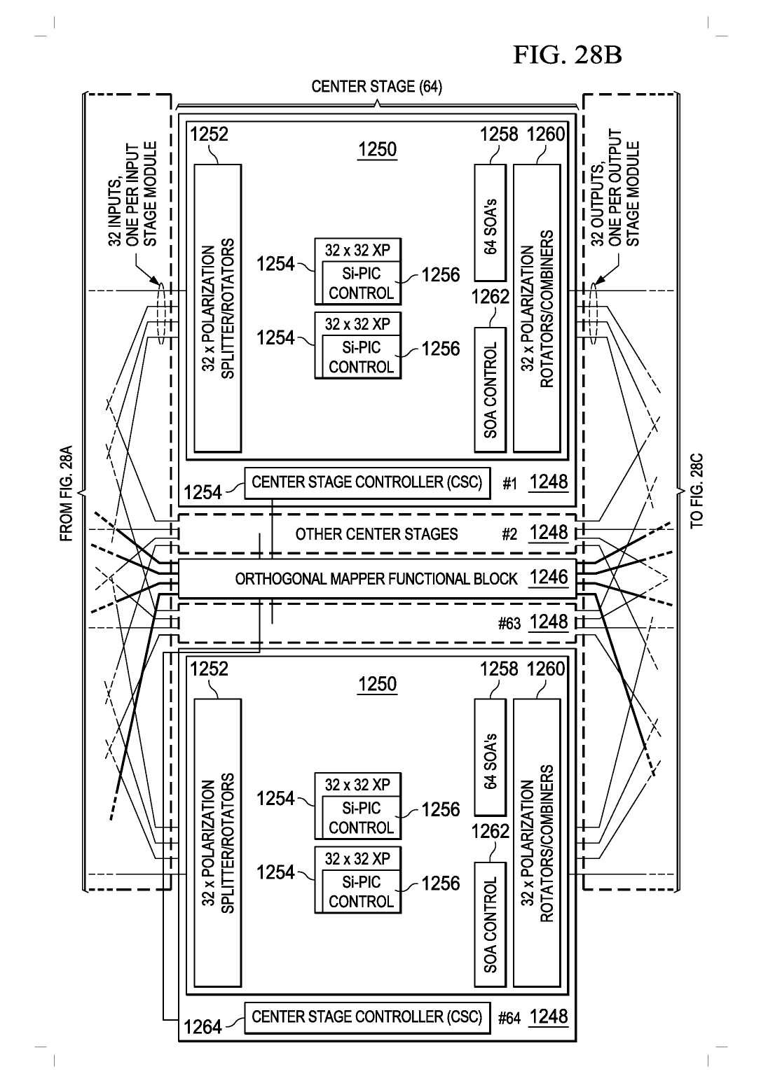

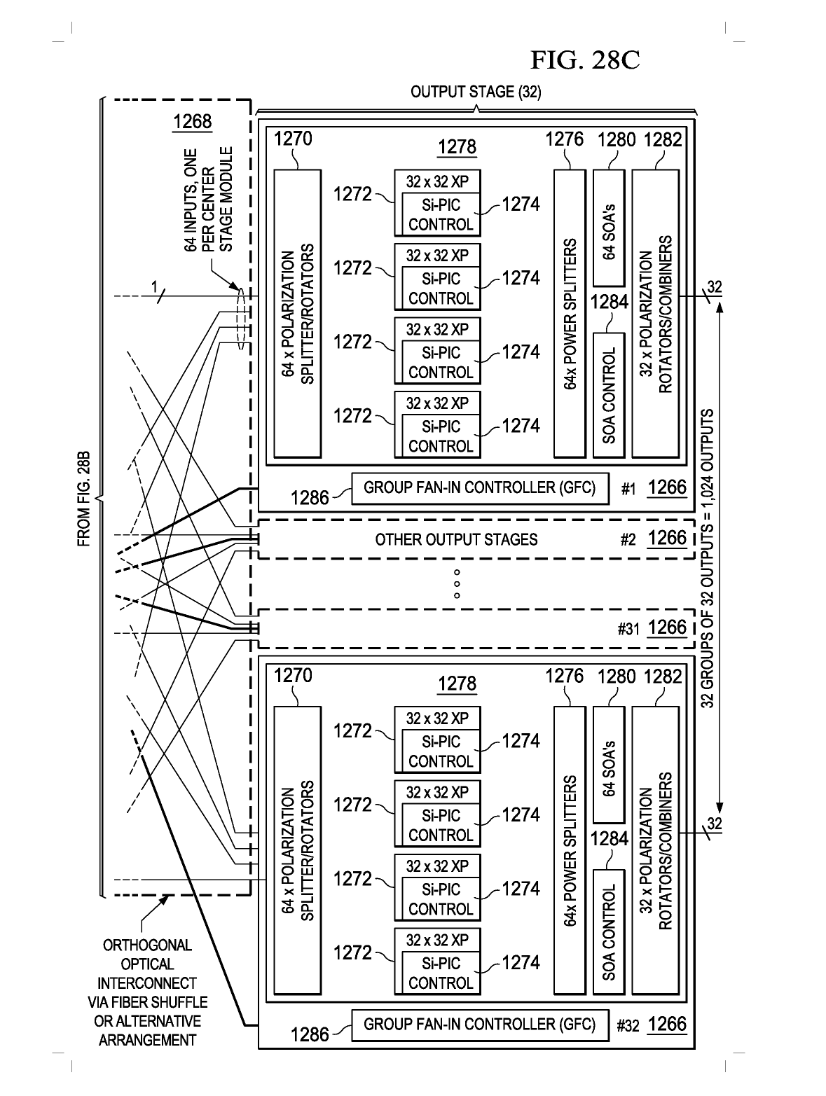

FIGS. 28A-C illustrate photonic switch 1220, a 1024×1024 dilated polarization agnostic switch using 32×32 PICs and optical macromodules. Photonic switch 1220 is a 1:2 dilated polarization agnostic Clos switch using distributed parallel pipelined real time control. The input stage, center stage, and output stage have macromodule arrays of 1×2, 1×1, and 2×1, respectively leading to 1:2 dilation in the input stages, 1:1 capacity gain in the center stages, and 2:1 inverse dilation in the output stages.

Input stage modules 1222 include optical macromodule 1224 and SMC 1242. The optical inputs are split by power splitters 1226, 32 90:10 power splitters which tap of a small portion of the optical power for phase detection, while the rest of the optical power is directed towards polarization splitters/rotators 1228. Polarization splitters/rotators 1228, 32 monolithic polarization splitters, separates the optical stream into two optical streams with orthogonal polarizations, and rotates the polarization of one of the optical streams by ninety degrees to output two optical streams with the same polarization. These optical streams are then split by power splitters 1230, 64 50:50 power splitters. The four optical streams are switched by PICs 1232, four 32×32 optical crosspoint switches controlled by PIC controllers 1234. The paths through the PIC chips are similar for low polarization skew. The macromodule trace path lengths are also matched. Because the PICs are square, the use of a 1×2 matrix within the macromodule structure with optically split inputs leads to dilation. After being switched, the optical signals are amplified by SOAs 1236, 128 polarization specific SOAs in SOA arrays controlled by SOA controller 1240. The amplified signals are combined by polarization rotators/combiners 1238, 64 monolithic polarization rotators to form polarization agnostic output optical streams.

The PIC connectivity map is uploaded every frame from the SMC to the PIC controller, which configures ever cell in the PIC switches. This may involve controlling every cell or converting the input connection map from the SMC into a cell-to-cell connection map for the PIC and applying that map to the cells in the switch. The PIC controller is mounted face-to-face with the PIC chip it controls so the optically active face of the PIC chip is electrically bonded directly to the active connections surface of the PIC controller chip. A well may be placed in the macromodule to accommodate the PIC controller and for electrical connections between the macromodule and the PIC controller to be via the PIC chip.

Input stages 1222 are orthogonally connected to center stage modules 1248 and orthogonal mapper module 1246 via optical interconnect 1244, an orthogonal interconnect, for example an optical fiber shuffle.

Center stage module 1248 includes optical macromodule 1224 and SMC 1242. The optical signals are input by polarization splitters/rotators 1252, 32 monolithic polarizations splitters/rotators which output two optical streams with the same polarization per input optical streams. These optical streams are switched by PICs 1254, 32×32 optical crosspoint switches which are controlled by PIC controllers 1256. The switched optical streams are then amplified by SOAs 1258, 64 polarization specific SOAs controlled by SOA controller 1262. Finally, the optical streams are combined by polarization rotators/combiners 1260, 32 monolithic polarization rotators/combiners. There is no dilation or macromodule capacity gain in the center stage.

The center stage modules and orthogonal mapper are orthogonally connected to output stage modules 1266 by optical interconnect 1268, which may be an orthogonal optical shuffle or another alternative providing low output skew.

The output stage modules include optical macromodule 1278 and GFC 1286. The optical signals are split and rotated by polarization splitters/rotators 1270, 64 monolithic polarization splitters/rotators, which output two optical streams with the same polarization per input optical stream. These streams are switched by PICs 1272, four 32×32 optical crosspoint switches controlled by PIC controllers 1274. The switched optical signals are combined by power combiners 1276, 64 power combiners. Then, the optical signals are amplified by SOAs 1280, 64 polarization specific SOAs controlled by SOA controllers 1284. Finally, the optical signals are combined by polarization rotators/combiners 1282, 32 monolithic polarization rotators/combiners, to output a polarization agnostic optical signal. Inverse dilation is performed in the output stage.

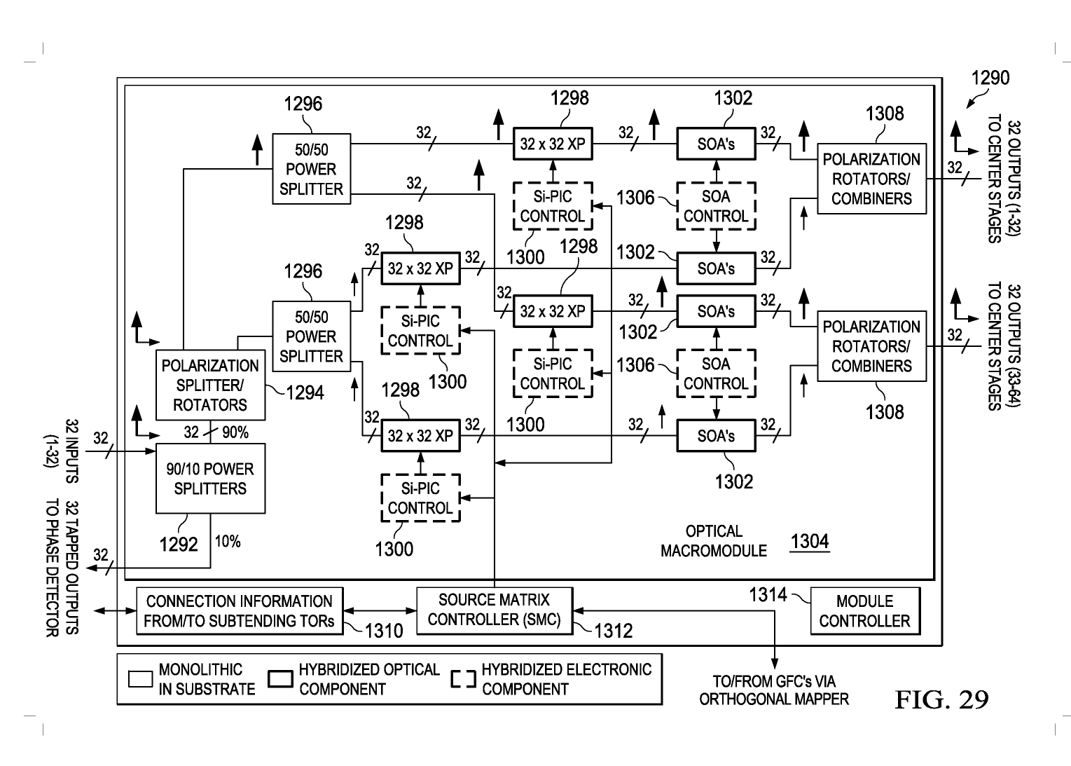

FIG. 29 illustrates input stage module 1290, a 1024×1024 polarization agnostic optical switch with optical macromodule 1304 and electronic components, including connection information block 1310, SMC 1312, and module controller 1314. The optical macromodule includes monolithic components, hybridized optical components, and hybridized electronic components. Power splitters 1292, polarization splitters/rotators 1294, power splitters 1296, and polarization rotators/combiners 1308 are monolithically integrated on the macromodule substrate. Additionally, PICs 1298 and SOAs 1302 are hybridized optical components, and PIC controllers 1300 and SOA controllers 1306 are hybridized electronic components.

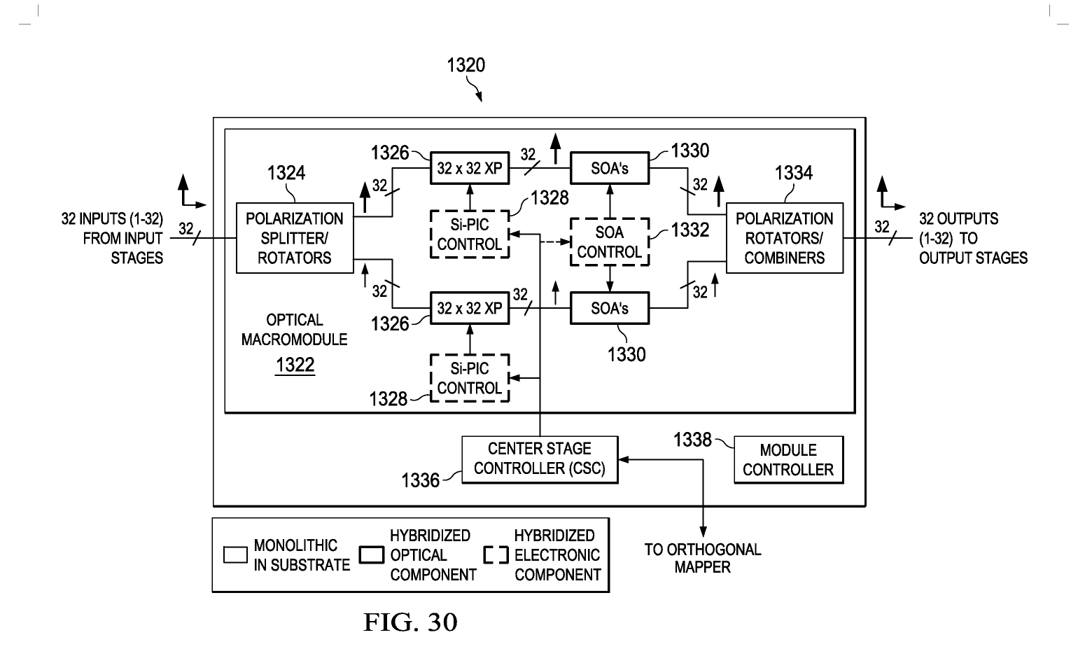

FIG. 30 illustrates center stage module 1320, an example center stage module for a 1024×1024 polarization agnostic photonic switch with optical macromodule 1322 and electronic components, including CSC 1336 and module controller 1338. The macromodule includes monolithic components polarization splitters/rotators 1324 and polarization rotators/combiners 1334. It also include hybridized components, including hybridized optical components of PICs 1326 and SOAs 1330 and optical hybridized components, PIC controllers 1328 and SOA controller 1332.

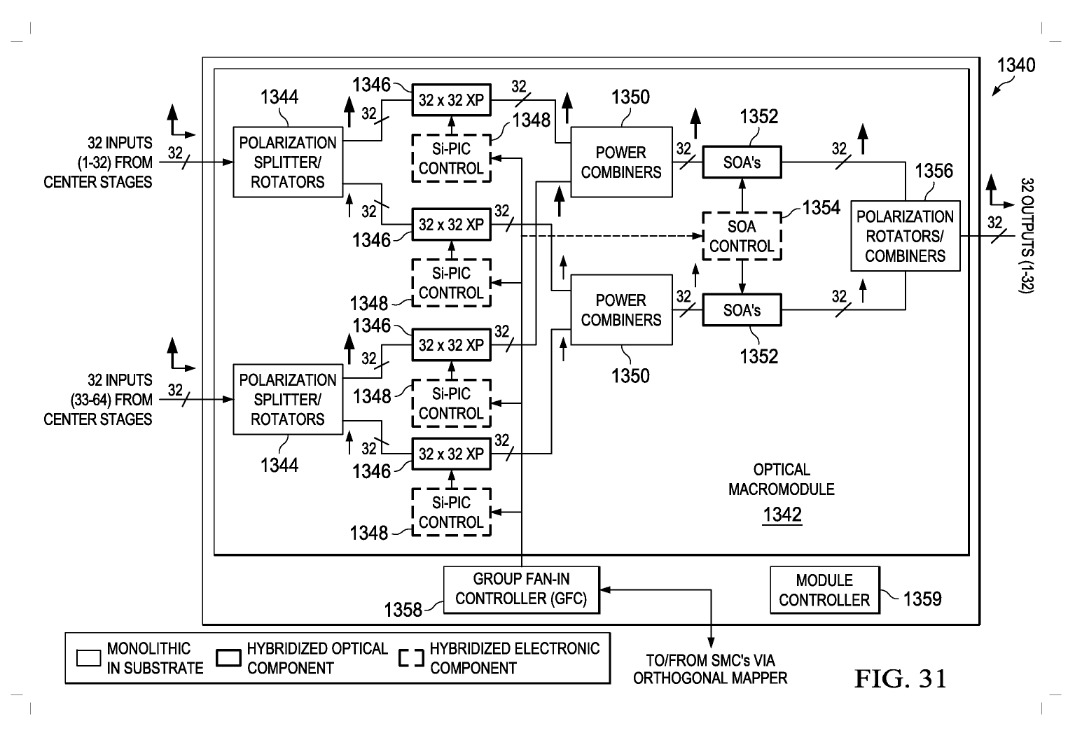

FIG. 31 illustrates an example output stage module for a 1024×1024 polarization agnostic photonic switch, output stage module 1340 with optical macromodule 1342 and electronic components, including GFC 1358 and module controller 1359. Monolithic components of the optical macromodule include polarization splitters/rotators 1344, power combiners 1350, and polarization rotators/combiners 1356. Also, optical hybridized components include PICs 1346 and SOAs 1352. Electronic hybridized components include PIC controller 1348 and SOA controller 1354.

Table 4, below, illustrates an example link budget for an example 1024×1024 polarization agnostic photonic switch.

TABLE 4

| Source Of Loss/Gain | Input Stage | | Center Stage | | Output Stage | |
|---|---|---|---|---|---|---|
| Input coupling | 1 | dB | 1 | dB | 1 | dB |
| 90/10 power splitter | 1 | dB | — | | — | |
| Polarization | 2.5 | dB | 2.5 | dB | 2.5 | dB |
| splitter/combiner | | | | | | |
| (total - both functions) | | | | | | |
| Power splitting to | 3 | dB | — | | — | |
| drive PIC pair | | | | | | |
| PIC chip coupling | 4 | dB | 4 | dB | 4 | dB |
| PIC chip losses | 6.5-7.8 | dB | 6.5-7.8 | dB | 6.5-7.8 | dB |
| SOA coupling | 3 | dB | 3 | dB | 3 | dB |
| Power combining | — | | — | | 3 | dB |
| from PIC pair | | | | | | |
| Macromodule output | 1 | dB | 1 | dB | 1 | dB |
| coupling | | | | | | |
| Total losses | 22.0-23.3 | dB | 18.0-19.3 | dB | 21.0-22.3 | dB |
| Required SOA Gain to | 17.0-18.3 | dB | 13.0-14.3 | dB | 16.0-17.3 | dB |
| reduce losses to 5 | | | | | | |
| dB per stage | | | | | | |

| | |
|---|---|
| Equalized SOA gain | 15.3-16.6 dB |
| for total 15 dB loss | |
| across switch | |

FIGS. 32A-C illustrates photonic switch 1730 for a 4096×4096 1:2 dilated polarization agnostic switch with 32×32 PICs for the center stage and 32×64 PICs for the input and output stages. The three stages have macromodule arrays of 4×1, 2×2, and 1×4 per polarization plane. By reversing the 64×32 to 32×64 and the 32×64 array to 64×32, the arrays would be 2×2, 2×2, 2×2. In both examples, this provides a capacity gain of 2 and 1:2 dilation for the input stage, a capacity gain of 2 for the center stage, and a capacity gain of 2 with inverse dilation of 2:1 for the output stage.

There are 64 input stages 1732 with optical macromodule 1734 and SMC 1752. In the input stage there is a 4×1 or 2×2 macromodule array for a 2:1 capacity gain and 1:2 dilation. Portions of the input optical signals are tapped off for phase detection by power splitters 1736, 64 90:10 optical power splitters. The optical signals are polarization split and rotated by polarization splitters/rotators 1738, 128 monolithic polarization splitters/rotators which output two optical streams having the same polarization. These optical streams are further split by power splitters 1740, 128 four way power splitters. The optical signals are switched by PICs 1742, eight 64×32 crosspoint optical switches controlled by PIC controllers 1744. The signals are then amplified by SOAs 1746, 256 single polarization SOAs controlled by SOA controller 1750. Next, the optical signals are combined by polarization rotator/combiners 1748, 128 monolithically integrated polarization rotators/combiners.

The input stage modules are orthogonally connected to center stage modules 1758, 128 center stage modules, and to orthogonal mapper 1756 by optical interconnect 1754, for example a fiber shuffle.

The center stage modules include optical macromodule 1760 and CSC 1776. No dilation is applied in the center stage modules. The input optical signals are polarization split and rotated by polarization splitters/rotators 1762, 64 monolithic devices, to produce two optical streams with the same polarization. These optical streams are further split by power splitters 1764, 128 50:50 power splitters. Then, the optical streams are switched by PICs 1766, eight 32×32 optical crosspoint switches organized as a pair of 2×2 arrays controlled by PIC controllers 1768. The optical signals are combined by power combiners 1772 and by polarization rotators/combiners 1774. The switched optical signals are then amplified by SOAs 1770, 128 single polarization SOAs controlled by SOA controller 1761.

The 128 center stage modules and the orthogonal mapper are orthogonally connected to output stages 1780, 64 output stage modules, by optical interconnect 1778, for example a fiber shuffle or a low skew solution.

In an output stage module, with GFC 1796 and optical macromodule 1782, receives the optical signals output by the center stage modules. Inverse dilation is performed by the output stage modules. The optical inputs are polarization split and rotated by polarization splitters/rotators 1784 which output two optical streams with the same polarization. The optical streams are switched by PICs 1786, eight 32×64 PICs controlled by PIC controllers 1788. The optical signals are combined by power combiners 1790, 128 four way power combiners. Then, the optical signals are amplified by SOAs 1792, 128 SOAs, which are controlled by SOA controller 1798. Finally, the polarization agnostic optical streams are output by polarization rotators/combiners 1794 which combine the polarization streams.

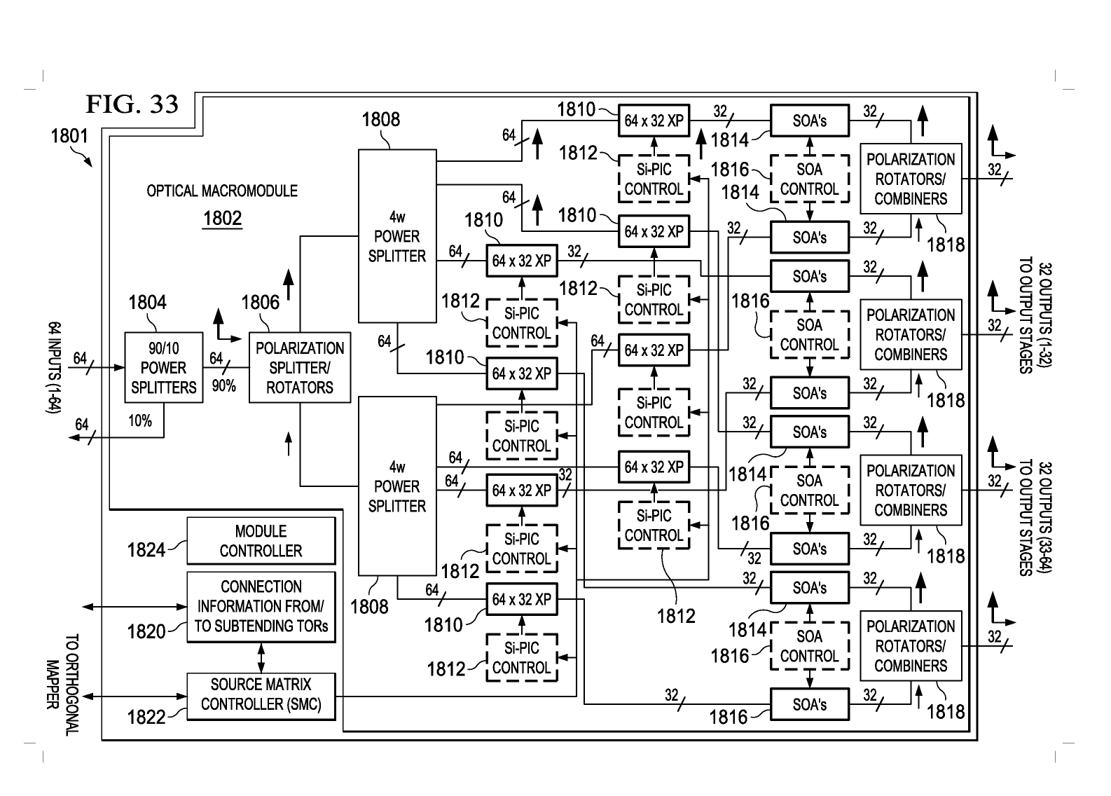

FIG. 33 illustrates input stage module 1801 for a polarization agnostic 4096×4096 photonic switch having optical macromodule 1802 and electronic components, such as connection information block 1820, SMC 1822, and module controller 1824. Power splitters 1804, polarization splitters/rotators 1806, power splitters 1808, and polarization rotators/combiners 1818 are monolithically integrated on the macromodule substrate. PICs 1810 and SOAs 1814 are hybridized optical components, and Si controllers 1812 and SOA controllers 1816 are hybridized electronic components.

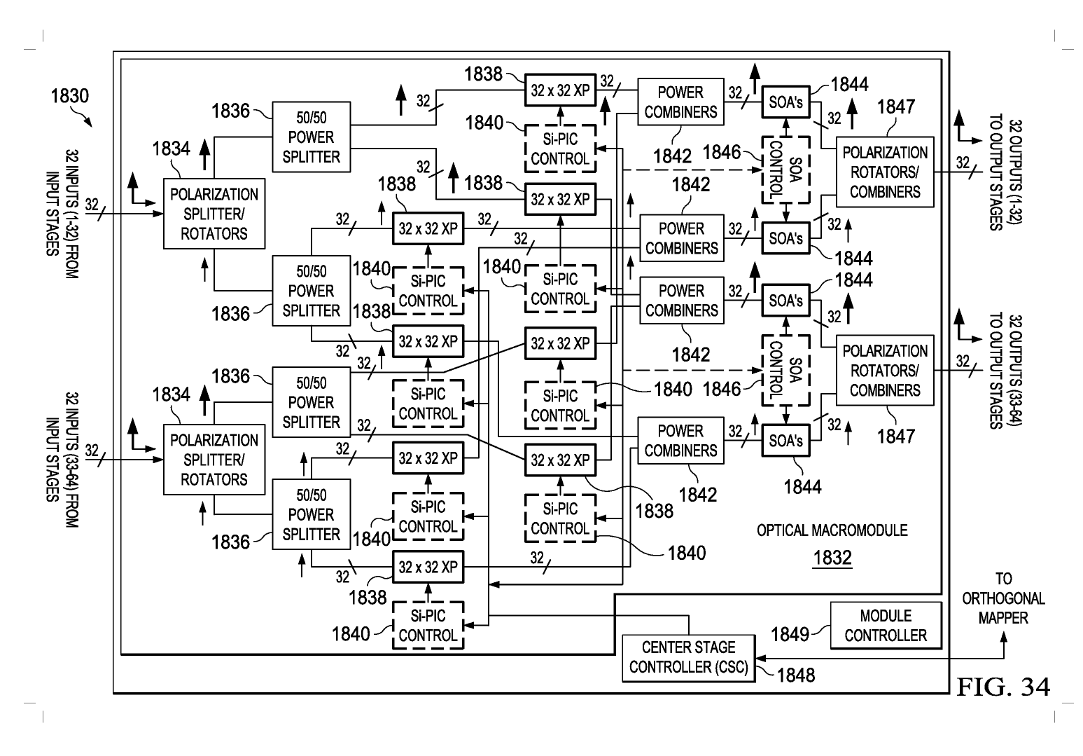

FIG. 34 illustrates center stage module 1830 for a polarization agnostic 4096×4096 photonic switch. The center stage module has optical macromodule 1832 and electronics such as CSC 1848 and module controller 1849. PICs 1838 and SOAs 1844 are hybridized optical components, and PIC controllers 1840 and SOA controllers 1846 are hybridized electronic components. Monolithic elements include polarization splitters/rotators 1834, power splitters 1836, power combiners 1842, and polarization rotators/combiners 1847.

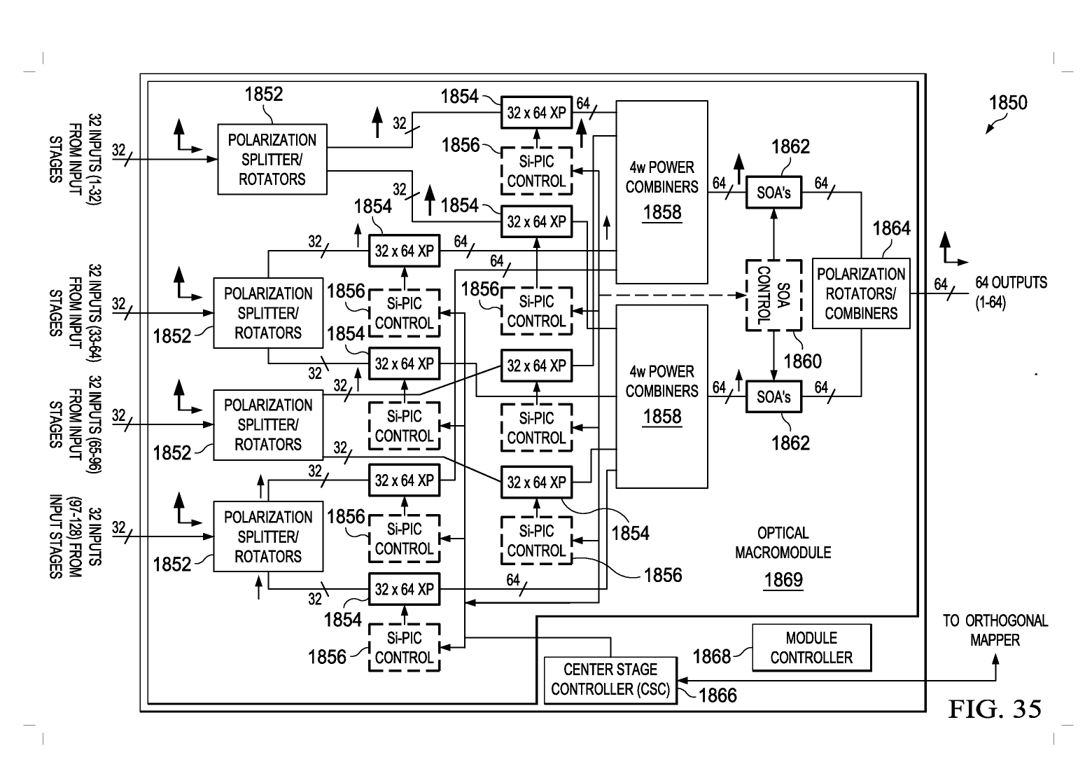

FIG. 35 illustrates output stage module 1850 for a polarization agnostic 4096×4096 photonic switch with optical macromodule 1869 and electronics including CSC 1866 and module controller 1868. Polarization splitters/rotators 1852, power combiners 1858, and polarization rotators/combiners 1864 are monolithically integrated in the macromodule substrate. PIC controllers 1856 and SOA controller 1860 are hybridized electronic components, and PICs 1854 and SOAs 1862 are hybridized optical components.

Table 5 illustrates an example link budget for a 4096×4096 polarization agnostic photonic switch.

TABLE 5

| Source Of Loss/Gain | Input Stage | | Center Stage | | Output Stage | |
|---|---|---|---|---|---|---|
| Input coupling | 1 | dB | 1 | dB | 1 | dB |
| 90/10 power splitter | 1 | dB | — | | — | |
| Polarization | 2 | dB | 2 | dB | 2 | dB |
| splitter/combiner | | | | | | |
| (total - both functions) | | | | | | |
| Power splitting to | 6 | dB | 3 | dB | — | |
| drive PIC pair/quad | | | | | | |
| PIC chip coupling | 3 | dB | 3 | dB | 3 | dB |
| PIC chip losses | 6.6-7.8 | dB | 6.0-7.2 | dB | 6.6-7.8 | dB |
| SOA coupling | 3 | dB | 3 | dB | 3 | dB |
| Power combining | — | | 3 | dB | 6 | dB |
| from PIC pair/quad | | | | | | |
| Macromodule output | 1 | dB | 1 | dB | 1 | dB |
| coupling | | | | | | |
| Total losses | 23.6-24.8 | dB | 22.0-23.2 | dB | 22.6-23.8 | dB |
| Required SOA Gain to | 18.6-19.8 | dB | 17.0-18.2 | dB | 17.6-18.8 | dB |
| reduce losses to 5 | | | | | | |
| dB per stage | | | | | | |

| | |
|---|---|
| Equalized SOA gain | 17.7-18.9 dB |
| for total 15 dB loss | |
| across switch | |

Another implementation of a 4096×4096 polarization-agnostic photonic switch fabric uses 32×32 PICs and doubles the number of PICs on the input stage and output stage macromodules. However, the PIC count on the macromodule is high, which may use a high yield for the precision production PIC mounting approach.

Table 6 displays some characteristics of input stage modules, Table 7 displays some characteristics of center stage modules, Table 8 displays some characteristics of output stage modules, and Table 9 displays some loss characteristic for large photonic switches. Substrate monolithic optical component include power splitters and combiners and polarization splitters and components. Hybridized optical components include PICs and SOA, listed as single SOAs. However, SOAs may be in arrays, for example of 8 or 16 SOAs per array, substantially reducing the number of hybridized optical components. Hybridized electronic components include SOA controllers and PIC controllers.

TABLE 6

| | | | Number of | | |
|---|---|---|---|---|---|
| | | Num- | monolith- | Number of | Number of |
| | | ber | ically | hybridized | hybridized |
| | PIC | of | integrated | optical | electronic |
| Switch Type | Size | PICs | components | components | Components |
| 256 × 256 | 16 × 32 | 2 | 64 | 66 | 3-4 |
| polarization | | | | | |
| agnostic | | | | | |
| 1024 × 1024 | 16 × 32 | 2 | 128 | 68 | 5-6 |
| single | | | | | |
| polarization | | | | | |
| 1024 × 1024 | 16 × 32 | 8 | 320 | 136 | 12-16 |
| polarization | | | | | |
| agnostic | | | | | |
| 1024 × 1024 | 32 × 32 | 2 | 64 | 66 | 3-4 |
| single | | | | | |
| polarization | | | | | |
| 1024 × 1024 | 32 × 32 | 4 | 192 | 132 | 6-8 |
| polarization | | | | | |
| agnostic | | | | | |
| 2048 × 2048 | 32 × 32 | 2 | 64 | 66 | 3-4 |
| single | | | | | |
| polarization | | | | | |
| 2048 × 2048 | 32 × 32 | 4 | 192 | 132 | 6-8 |
| polarization | | | | | |
| agnostic | | | | | |
| 4096 × 4096 | 32 × 32 | 8 | 256 | 136 | 12-16 |
| single | | | | | |
| polarization | | | | | |
| 4096 × 4096 | 32 × 64 | 8 | 384 | 264 | 16-24 |
| polarization | | | | | |
| agnostic | | | | | |

TABLE 7

| | | | Number of | | |
|---|---|---|---|---|---|
| | | Num- | monolith- | Number of | Number of |
| | | ber | ically | hybridized | hybridized |
| | PIC | of | integrated | optical | electronic |
| Switch Type | Size | PICs | components | components | Components |
| 256 × 256 | 16 × 16 | 2 | 32 | 34 | 3-4 |
| polarization | | | | | |
| agnostic | | | | | |
| 1024 × 1024 | 16 × 32 | 2 | 32 | 34 | 3-4 |
| single | | | | | |
| polarization | | | | | |
| 1024 × 1024 | 16 × 32 | 4 | 128 | 68 | 6-8 |
| polarization | | | | | |
| agnostic | | | | | |
| 1024 × 1024 | 32 × 32 | 1 | 0 | 33 | 3-4 |
| single | | | | | |
| polarization | | | | | |
| 1024 × 1024 | 32 × 32 | 2 | 64 | 66 | 3-4 |
| polarization | | | | | |
| agnostic | | | | | |
| 2048 × 2048 | 32 × 32 | 4 | 128 | 72 | 6-8 |
| single | | | | | |
| polarization | | | | | |
| 2048 × 2048 | 32 × 32 | 8 | 384 | 136 | 12-16 |
| polarization | | | | | |
| agnostic | | | | | |
| 4096 × 4096 | 32 × 32 | 4 | 128 | 72 | 6-8 |
| single | | | | | |
| polarization | | | | | |
| 4096 × 4096 | 32 × 32 | 8 | 384 | 136 | 12-16 |
| polarization | | | | | |
| agnostic | | | | | |

TABLE 8

| | | | Number of | | |
|---|---|---|---|---|---|
| | | Num- | monolith- | Number of | Number of |
| | | ber | ically | hybridized | hybridized |
| | PIC | of | integrated | optical | electronic |
| Switch Type | Size | PICs | components | components | Components |
| 256 × 256 | 16 × 32 | 2 | 48 | 34 | 3-4 |
| polarization | | | | | |
| agnostic | | | | | |
| 1024 × 1024 | 16 × 32 | 2 | 96 | 36 | 5-6 |
| single | | | | | |
| polarization | | | | | |
| 1024 × 1024 | 16 × 32 | 8 | 288 | 72 | 12-16 |
| polarization | | | | | |
| agnostic | | | | | |
| 1024 × 1024 | 32 × 32 | 2 | 32 | 34 | 3-4 |
| single | | | | | |
| polarization | | | | | |
| 1024 × 1024 | 32 × 32 | 4 | 160 | 6-8 | 68 |
| polarization | | | | | |
| agnostic | | | | | |
| 2048 × 2048 | 32 × 32 | 2 | 32 | 34 | 3-4 |
| single | | | | | |
| polarization | | | | | |
| 2048 × 2048 | 32 × 32 | 4 | 160 | 68 | 6-8 |
| polarization | | | | | |
| agnostic | | | | | |
| 4096 × 4096 | 32 × 32 | 8 | 192 | 72 | 12-16 |
| single | | | | | |
| polarization | | | | | |
| 4096 × 4096 | 32 × 64 | 8 | 320 | 136 | 16-24 |
| polarization | | | | | |
| agnostic | | | | | |

TABLE 9

| | Input stage | Center stage | Output stage | |
|---|---|---|---|---|
| | module | module | module | |
| | optical | optical | optical | Per SOA |
| Switch Type | loss (dB) | loss (dB) | loss (dB) | gain |
| 256 × 256 | 19.3-20.7 | 17.6-19.0 | 18.3-19.7 | 13.4-14.8 |
| polarization | | | | |
| agnostic | | | | |
| 1024 × 1024 | 22.3-23.7 | 18.3-19.7 | 21.3-22.7 | 15.6-17.0 |
| single | | | | |
| polarization | | | | |
| 1024 × 1024 | 25.3-26.7 | 21.3-22.7 | 24.3-25.7 | 18.6-20.0 |
| polarization | | | | |
| agnostic | | | | |
| 1024 × 1024 | 19.5-20.8 | 15.5-16.8 | 18.5-19.8 | 12.8-14.1 |
| single | | | | |
| polarization | | | | |
| 1024 × 1024 | 22.0-23.3 | 18.0-19.3 | 21.0-22.3 | 15.3-16.6 |
| polarization | | | | |
| agnostic | | | | |
| 2048 × 2048 | 18.5-21.7 | 20.5-21.7 | 17.5-18.7 | 12.8-14.0 |
| single | | | | |
| polarization | | | | |
| 2048 × 2048 | 20.5-21.7 | 22.5-23.7 | 19.5-20.7 | 14.8-16.0 |
| polarization | | | | |
| agnostic | | | | |
| 4096 × 4096 | 24.0-25.2 | 17.0-18.2 | 23.0-24.2 | 16.3-17.5 |
| single | | | | |
| polarization | | | | |
| 4096 × 4096 | 23.6-24.8 | 22.0-23.2 | 22.6-23.8 | 17.7-18.9 |
| polarization | | | | |
| agnostic | | | | |

Delays in separate polarization paths are designed to be similar, for example within 200 μm to 400 μm for 100 Gb/s or 800 μm to 1.6 mm at 25 Gb/s. In some examples, power splitting occurs before polarization splitting to reduce the polarization skew. In another example, polarization splitting occurs on the PIC to further reduce the polarization delay. However, placing two switching matrices on a single PIC along with polarization splitters, combiners, and rotators more than doubles the die size or halves the PIC port count for the same die size.

Table 10 discusses the estimated die size for single polarization PIC switching matrices with HDBE and EAS topology. Using EAS increases the die size. Using two switches plus polarization splitters, rotators, and combiners increases the die size. Table 17 shows the die sizes for polarization agnostic HDBE switching matrices. Table 18 shows a comparison of PIC counts for macromodules with various PICs and different switching port counts.

Table 11 shows that HDBE PICs may be designed in silicon up to 64×64 port parts before reaching 25×32 mm. However, directly addressable and totally non-blocking EAS parts are limited to 32×32 before reaching 25×32 mm.

Table 12 shows that the size of a polarization agnostic chip is approaching that of a single polarization part of twice the port count.

TABLE 10

| | | | | Edge | |
|---|---|---|---|---|---|
| | Cell | | | space | Die |
| Matrix | Size | Number | Routing | allo- | Size |
| Size | (μm) | of Cells | Overhead | cation | (mm) |
| 16 × 16 | 100 × 1300 | 192 | 50% | 1 mm | 8 × 8 |
| 32 × 32 HDBE | 100 × 1300 | 448 | 120% | 1 mm | 13 × 13 |
| 64 × 64 HDBE | 100 × 1300 | 1024 | 160% | 1 mm | 20 × 20 |
| 16 × 16 EAS | 100 × 1300 | 480 | 100% | 1 mm | 13 × 13 |
| 32 × 32 EAS | 100 × 1300 | 1984 | 130% | 1 mm | 25 × 28 |
| 64 × 64 EAS | 100 × 1300 | 8064 | | | |

Hence, for any given die size limit the capacity of a polarization-agnostic part is one half of that of a single polarization part, requiring four parts in a 2×2 array to match the capacity of a PIC in a single polarization implementation. However, two of those single polarization PICs plus external macromodule polarization components can yield the same size of polarization agnostic switch. Thus, placing the polarization components on the macromodule reduces the PIC count by a factor of 2.

TABLE 11

| | | Polarization | | |
|---|---|---|---|---|
| | | devices | Total | |
| | | area with | active | Die size with |
| Matrix | Matrix | interconnect | area | 1 mm edge |
| Size | Area (A) | o/head (B) | (2*A + B) | zones |
| 16 × 16 | 6 × 6 mm = | 17.3 square | 89.3 square | 11.4 mm × |
| | 36 square mm | mm | mm | 11.4 mm |
| 32 × 32 | 11 mm × 11 mm = | 34.6 square | 276.6 square | 18.6 mm × |
| | 121 sq mm | mm | mm | 18.6 mm |
| 64 × 64 | 18 mm × 18 mm = | 69.1 square | 717.1 square | 25 mm × |
| | 324 square mm | mm | mm | 33 mm |

TABLE 12

| | 32 × 32 Single | | 16 × 16 | | | |
|---|---|---|---|---|---|---|
| | Polarization | | Polarization | | 32 × 32 Polarization | |
| | PIC | | Agnostic PIC | | Agnostic PIC | |
| | Input & | | Input & | | Input & | |
| | Output | Center | Output | Center | Output | Center |
| Switch Size | Stages | Stage | Stages | Stage | Stages | Stage |
| 1024 × 1024 | 4 | 2 | 8 | 4 | 2 | 1 |
| 2048 × 2048 | 4 | 8 | 8 | 16 | 2 | 4 |
| 4096 × 4096 | 16 | 8 | 32 | 16 | 8 | 4 |

Table 13 shows estimated component footprint allocations for hybridized and monolithic components used in macromodules, which includes an overhead interconnect allocation for each device.

TABLE 13

| | | Overhead for | Effective Area With |
|---|---|---|---|
| | Area | Macromodule | Interconnect |
| Device | (square mm) | Interconnect | (square mm) |
| 16 × 16 PIC | 64 | 200% | 192 |
| 16 × 32 PIC | 110 | 200% | 330 |
| 32 × 32 PIC | 169 | 200% | 507 |
| 32 × 64 PIC | 270 | 200% | 810 |
| 64 × 64 PIC | 400 | 200% | 1200 |
| 8 * SOA array | 4 | 300% | 16 |
| Polarization. | 0.3 | 500% | 1.5 |
| Split/Rotate or | | | |
| Rotate/combine | | | |
| Power split/combine | <0.3 | 500% | 1.5 |
| PIC controller | on PIC | — | — |
| SOA controller | 15 | 200% | 45 |
| (1 per 16 SOAs) | | | |

Table 14 shows the area for input stage macromodules for 1024×1024 and 4096×4096 switches, Table 15 shows a the area for the center stage macromodules for 1024×1024 and 4096×4096 switches, and Table 16 shows a the area for the output stage macromodules for 1024×1024 and 4096×4096 switches. The photonically functional active areas, including interconnect, ranges from about 602 square mm to about 11,692 square mm, corresponding to about 25 mm per side up to 108 mm per side. These sizes are compatible with large area silica on silicon substrate processing, such as complex silica based high port count array waveguide grating (AWG) fabrication.

TABLE 14

| | 1024 × 1024 | 1024 × 1024 | 4096 × 4096 | 4096 × 4096 |
|---|---|---|---|---|
| | Single | Polarization | Single | Polarization |
| | Polarization | Agnostic | Polarization | Agnostic |
| PIC Port count | 32 × 32 | 32 × 32 | 32 × 32 | 32 × 64 |
| PIC Area | 1014 | 2028 | 4056 | 6480 |
| (square mm) | | | | |
| Area of | 96 | 288 | 384 | 576 |
| Substrate | | | | |
| Monolithic | | | | |
| Components | | | | |
| (square mm) | | | | |
| Area of | 1024 | 2048 | 2048 | 4096 |
| Hybridized | | | | |
| Photonic | | | | |
| Components | | | | |
| excluding PIC | | | | |
| (square mm) | | | | |
| Area of | 90 | 180 | 360 | 540 |
| Hybridized | | | | |
| Electronic | | | | |
| Components | | | | |
| (square mm) | | | | |
| Total Area | 2224 | 4544 | 6848 | 11,692 |
| (square mm) | | | | |
| Macromodule | 47 × 47 | 67 × 67 | 83 × 83 | 108 × 108 |
| Active | | | | |
| Footprint | | | | |
| (mm × mm) | | | | |

TABLE 15

| | 1024 × 1024 | 1024 × 1024 | 4096 × 4096 | 4096 × 4096 |
|---|---|---|---|---|
| | Single | Polarization | Single | Polarization |
| | Polarization | Agnostic | Polarization | Agnostic |
| PIC Port count | 32 × 32 | 32 × 32 | 32 × 32 | 32 × 32 |
| PIC Area | 507 | 1014 | 2028 | 4056 |
| (square mm) | | | | |
| Area of | 0 | 96 | 192 | 576 |
| Substrate | | | | |
| Monolithic | | | | |
| Components | | | | |
| (square mm) | | | | |
| Area of | 512 | 1024 | 1024 | 2048 |
| Hybridized | | | | |
| Photonic | | | | |
| Components | | | | |
| excluding PIC | | | | |
| (square mm) | | | | |
| Area of | 90 | 90 | 180 | 360 |
| Hybridized | | | | |
| Electronic | | | | |
| Components | | | | |
| (square mm) | | | | |
| Total Area | 602 | 2224 | 3424 | 7040 |
| (square mm) | | | | |
| Macromodule | 25 × 25 | 47 × 47 | 59 × 59 | 84 × 84 |
| Active | | | | |
| Footprint | | | | |
| (mm × mm) | | | | |

TABLE 16

| | 1024 × 1024 | 1024 × 1024 | 4096 × 4096 | 4096 × 4096 |
|---|---|---|---|---|
| | Single | Polarization | Single | Polarization |
| | Polarization | Agnostic | Polarization | Agnostic |
| PIC port count | 32 × 32 | 32 × 32 | 32 × 32 | 32 × 64 |
| PIC Area | 1014 | 2028 | 4056 | 6480 |
| (square mm) | | | | |
| Area of | 48 | 240 | 288 | 480 |
| Substrate | | | | |
| Monolithic | | | | |
| Components | | | | |
| (square mm) | | | | |
| Area of | 512 | 1024 | 1024 | 2048 |
| Hybridized | | | | |
| Photonic | | | | |
| Components | | | | |
| excluding PIC | | | | |
| (square mm) | | | | |
| Area of | 90 | 108 | 360 | 540 |
| Hybridized | | | | |
| Electronic | | | | |
| Components | | | | |
| (square mm) | | | | |
| Total Area | 1664 | 3472 | 5796 | 9548 |
| (square mm) | | | | |
| Macromodule | 41 × 41 | 59 × 59 | 76 × 76 | 98 × 98 |
| Active | | | | |
| Footprint | | | | |
| (mm × mm) | | | | |

PICs may be assembled into an N×M array on the macromodule. A 2×2 matrix has two rows of PICs and two columns of PICs with the PICs in a row having inputs connected to the same source as the same inputs on the other PIC(s) in the row using an optical power splitter, while the PICs in each column have each of their outputs connected to the same output of the other PICs in the column using an optical combiner. This creates a directly addressable non-blocking switching module having the same addressing characteristics as the constituent PICs. The capacity of the switching core is N times the input port count of the individual PIC and M times the output port capacity of the individual PICs. Table 24 shows the macromodule core switching capacity as a function of core configuration.

TABLE 17

| MM Switch core | # of | PIC Size | | | |
|---|---|---|---|---|---|
| configuration | PICs | 16 × 16 | 16 × 32 | 32 × 32 | 32 × 64 |
| 1 × 2 | 2 | 16 × 32 | 32 × 32 | 32 × 64 | 64 × 164 |
| 2 × 2 | 4 | 32 × 32 | 32 × 64 | 64 × 64 | 64 × 128 |
| 2 × 4 | 8 | 32 × 64 | 64 × 64 | 64 × 128 | 128 × 128 |
| 4 × 4 | 16 | 64 × 64 | 64 × 128 | 128 × 128 | 128 × 256 |

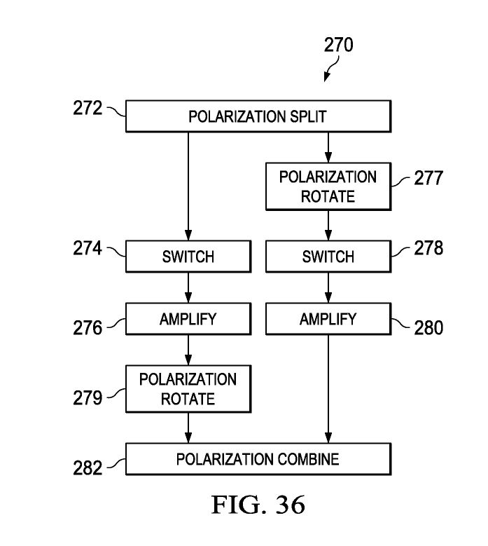

FIG. 36 illustrates flowchart 270 of an embodiment method of embodiment photonic switching. Initially, in step 272, an input optical stream is polarization split and rotated. The input optical stream is split into two optical streams with orthogonal polarizations. One of these optical streams is polarization rotated by ninety degrees to produce two optical streams with the same polarization.

In step 274, one of the optical streams is switched, for example by a PIC, for example a semiconductor crosspoint switch.

Then, this switched optical stream is amplified in step 276, for example by an SOA or EDWA.

Next, in step 279, the polarization of the amplified optical stream is rotated, for example by ninety degrees.

In step 277, the polarization of the other optical stream is rotated, for example by ninety degrees.

In step 278, the other optical stream is switched. Next, in step 280, this switched optical stream is amplified.

Finally, in step 282, these two switched and amplified optical streams are polarization rotated and combined. One of the optical streams is polarization rotated by ninety degrees, and the streams are combined to form an output optical stream.

An embodiment photonic device includes an optical macromodule substrate including optical interconnects and a first photonic integrated circuit (PIC) including a first photonic switch, where the first PIC is mechanically coupled to the optical macromodule substrate and optically coupled to the optical interconnect. The photonic device also includes a PIC controller electrically coupled to the first PIC.

The embodiment also includes a second PIC comprising a second photonic switch, where the second PIC is mechanically coupled to the optical macromodule substrate and optically coupled to the optical interconnect. In one example, the optical macromodule substrate further includes an optical polarization splitter/rotator, where the optical polarization splitter/rotator is optically coupled to the first PIC and the second PIC. In another example, the optical macromodule substrate further includes an optical polarization rotator/combiner, where the optical polarization rotator/combiner is optically coupled to the first PIC and the second PIC. An additional embodiment includes a square array or a non-square array of PICs, including the first PIC and the second PIC. For example, if the square array comprises the first PIC and the second PIC, the macromodule has M inputs, where the first PIC has a port count of P, where M=N*P, and where the square array of PICs is an N×N array of PICs.

In an embodiment, the optical macromodule substrate further includes an optical power splitter, where the optical power splitter is optically coupled to the first PIC and an optical power combiner, where the optical power combiner is optically coupled to the first PIC.

A further embodiment includes a semiconductor optical amplifier (SOA) mechanically and optically coupled to the macromodule substrate and an SOA controller mechanically and electrically coupled to the SOA. For example, the SOA controller is configured to turn the SOA off when the SOA is not transmitting an optical packet. In another example, the SOA controller is configured to receive output port utilization information from the PIC controller.

In an additional embodiment, the first PIC has an active surface, where the PIC controller has an active surface, and where the active surface of the PIC controller is disposed on the active surface of the first PIC.

In another embodiment, the optical macromodule substrate has a well or aperture, where the PIC controller is in the well, and where a first surface of the PIC controller is level with a top of the optical macromodule substrate.

In an embodiment, the optical macromodule further includes an optical coupler, where the optical coupler is configured to optically couple the optical macromodule to an external optical device.

An embodiment photonic switch includes an input stage including a first optical including a first photonic integrated circuit (PIC) switch and a second optical macromodule including a second PIC switch. The photonic switch also includes a center stage including a third optical macromodule including a third PIC switch, where the third optical macromodule is optically coupled to the first optical macromodule and the second optical macromodule and a fourth optical macromodule including a fourth PIC switch, where the fourth optical macromodule is optically coupled to the first optical macromodule and the second optical macromodule. Additionally, the photonic switch includes an output stage including a fifth optical macromodule including a fifth PIC switch, where the fifth optical macromodule is optically coupled to the third optical macromodule and the fourth optical macromodule and a sixth optical macromodule including a sixth PIC switch, where the sixth optical macromodule is optically coupled to the third optical macromodule and the fourth optical macromodule.

In a further embodiment, the first optical macromodule further includes a seventh PIC, where the second optical macromodule further includes an eighth PIC, where the third optical macromodule further includes a ninth PIC, where the fourth optical macromodule further includes a tenth PIC, where the fifth PIC further includes an eleventh PIC, and where the sixth PIC further includes a twelfth PIC.

In an embodiment, the first macromodule further includes a first polarization splitter optically coupled to the first PIC and to the seventh PIC and a first polarization combiner optically coupled to the first PIC and to the seventh PIC, and where the second macromodule further includes a second polarization splitter optically coupled to the second PIC and to the eighth PIC and a second polarization combiner optically coupled to the second PIC and to the eighth PIC. Also, in this embodiment a semiconductor optical amplifier (SOA) is coupled between the first polarization splitter and the polarization combiner.

In an additional embodiment, the center stage further includes a center stage controller electrically coupled to the third optical macromodule.

In another embodiment, the photonic switch is a three stage Clos photonic switch.

An embodiment method includes receiving an input optical stream and producing a first split optical stream having a first polarization and a second split optical stream having the first polarization from the input optical stream by a polarization splitter/rotator. The method also includes switching the first split optical stream to produce a first switched optical stream by a first optical switch and amplifying the first switched optical stream to produce a first amplified optical stream by a first amplifier. Additionally, the method includes switching the second optical stream to produce a second switched optical stream by a second optical switch and amplifying the second switched optical stream to produce a second amplified optical stream by a second amplifier. Also, the method includes combining the first amplified optical stream and the second amplified optical stream to produce a polarization agnostic optical stream by a polarization rotator/combiner.

In an embodiment, a first path from the polarization splitter/rotator through the first optical switch and the first optical amplifier to the polarization rotator has a first distance, where a second path from the polarization splitter/rotator through the second optical switch and the second optical amplifier to the polarization rotator has a second distance, and where the first distance is within 2 mm of the second distance.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. A photonic device comprising:
an optical macromodule substrate comprising optical interconnects;
a first photonic integrated circuit (PIC) comprising a first photonic switch, wherein the first PIC is mechanically coupled to the optical macromodule substrate and optically coupled to the optical interconnect; and
a PIC controller electrically coupled to the first PIC.

2. The photonic device of claim 1, further comprising a second PIC comprising a second photonic switch, wherein the second PIC is mechanically coupled to the optical macromodule substrate and optically coupled to the optical interconnect.

3. The photonic device of claim 2, wherein the optical macromodule substrate further comprises an optical polarization splitter/rotator, wherein the optical polarization splitter/rotator is optically coupled to the first PIC and the second PIC.

4. The photonic device of claim 2, wherein the optical macromodule substrate further comprises an optical polarization rotator/combiner, wherein the optical polarization rotator/combiner is optically coupled to the first PIC and the second PIC.

5. The photonic device of claim 2, further comprising a square array or a non-square array of PICs, comprising the first PIC and the second PIC.

6. The photonic device of claim 5, wherein if the square array comprises the first PIC and the second PIC, the macromodule has M inputs, wherein the first PIC has a port count of P, wherein M=N*P, and wherein the square array of PICs is an N×N array of PICs.

7. The photonic device of claim 1, wherein the optical macromodule substrate further comprises:
an optical power splitter, wherein the optical power splitter is optically coupled to the first PIC; and
an optical power combiner, wherein the optical power combiner is optically coupled to the first PIC.

8. The photonic device of claim 1, further comprising:
a semiconductor optical amplifier (SOA) mechanically and optically coupled to the macromodule substrate; and
an SOA controller mechanically and electrically coupled to the SOA.

9. The photonic device of claim 8, wherein the SOA controller is configured to turn the SOA off when the SOA is not transmitting an optical packet.

10. The photonic device of claim 9, wherein the SOA controller is configured to receive output port utilization information from the PIC controller.

11. The photonic device of claim 1, wherein the first PIC has an active surface, wherein the PIC controller has an active surface, and wherein the active surface of the PIC controller is disposed on the active surface of the first PIC.

12. The photonic device of claim 1, wherein the optical macromodule substrate has a well or aperture, wherein the PIC controller is in the well, and wherein a first surface of the PIC controller is level with a top of the optical macromodule substrate.

13. The photonic device of claim 1, wherein the optical macromodule further comprises an optical coupler, wherein the optical coupler is configured to optically couple the optical macromodule to an external optical device.

14. A photonic switch comprising:
an input stage comprising
a first optical macromodule comprising a first photonic integrated circuit (PIC) switch, and
a second optical macromodule comprising a second PIC switch;
a center stage comprising
a third optical macromodule comprising a third PIC switch, wherein the third optical macromodule is optically coupled to the first optical macromodule and the second optical macromodule, and
a fourth optical macromodule comprising a fourth PIC switch, wherein the fourth optical macromodule is optically coupled to the first optical macromodule and the second optical macromodule; and
an output stage comprising
a fifth optical macromodule comprising a fifth PIC switch, wherein the fifth optical macromodule is optically coupled to the third optical macromodule and the fourth optical macromodule, and
a sixth optical macromodule comprising a sixth PIC switch, wherein the sixth optical macromodule is optically coupled to the third optical macromodule and the fourth optical macromodule.

15. A photonic switch of claim 14, wherein the first optical macromodule further comprises a seventh PIC, wherein the second optical macromodule further comprises an eighth PIC, wherein the third optical macromodule further comprises a ninth PIC, wherein the fourth optical macromodule further comprises a tenth PIC, wherein the fifth PIC further comprises an eleventh PIC, and wherein the sixth PIC further comprises a twelfth PIC.

16. The photonic switch of claim 15, wherein the first macromodule further comprises a first polarization splitter optically coupled to the first PIC and to the seventh PIC and a first polarization combiner optically coupled to the first PIC and to the seventh PIC, and wherein the second macromodule further comprises a second polarization splitter optically coupled to the second PIC and to the eighth PIC and a second polarization combiner optically coupled to the second PIC and to the eighth PIC.

17. The photonic switch of claim 16, wherein a semiconductor optical amplifier (SOA) is coupled between the first polarization splitter and the polarization combiner.

18. The photonic switch of claim 14, wherein the center stage further comprises a center stage controller electrically coupled to the third optical macromodule.

19. The photonic switch of claim 14, wherein the photonic switch is a three stage Clos photonic switch.

20. A method comprising:
receiving an input optical stream;
producing a first split optical stream having a first polarization and a second split optical stream having the first polarization from the input optical stream by a polarization splitter/rotator;
switching the first split optical stream to produce a first switched optical stream by a first optical switch;
amplifying the first switched optical stream to produce a first amplified optical stream by a first amplifier;
switching the second optical stream to produce a second switched optical stream by a second optical switch;
amplifying the second switched optical stream to produce a second amplified optical stream by a second amplifier; and
combining the first amplified optical stream and the second amplified optical stream to produce a polarization agnostic optical stream by a polarization rotator/combiner.

21. The method of claim 20, wherein a first path from the polarization splitter/rotator through the first optical switch and the first optical amplifier to the polarization rotator has a first distance, wherein a second path from the polarization splitter/rotator through the second optical switch and the second optical amplifier to the polarization rotator has a second distance, and wherein the first distance is within 2 mm of the second distance.
